(19) United States
(12) Patent Application Publication
(10) Pub. No.: US 2026/0361997 A1
(43) Pub. Date: Nov. 12, 2026

(54) ELECTRONIC DEVICE AND IMAGING APPARATUS

(71) Applicant: Panasonic Intellectual Property Management Co., Ltd., Osaka (JP)

(72) Inventor: Kazuhiro OGAWA, Osaka (JP)

(73) Assignee: Panasonic Intellectual Property Management Co., Ltd., Osaka (JP)

(21) Appl. No.: 19/671,322

(22) Filed: May 8, 2026

(30) Foreign Application Priority Data
May 12, 2025 (JP) 2025-080015

(51) Int. Cl. H04N 23/65; H02J 4/00; H02J 7/70; H02M 7/06

(52) U.S. Cl. CPC H04N 23/65; H02J 4/00; H02J 7/70; H02M 7/06

(57) ABSTRACT

An electronic device comprises a load circuit, a combining circuit having a first terminal and a second terminal, a first power-supply terminal, a second power-supply terminal, and a power-receiving circuit. The combining circuit outputs, to the load circuit, a combined power obtained by combining power input to the first terminal and power input to the second terminal. Power supplied to the first terminal is input to the first power-supply terminal from a first power supply. Power supplied to the second terminal is input to the second power-supply terminal from a second power supply. The power-receiving circuit receives power input to the first power-supply terminal. The output of the power-receiving circuit is input to the first terminal. Standards for the first power supply include a first standard and a second standard capable of supplying a larger power than the first standard. The power-receiving circuit conforms to the first standard.

### CROSS REFERENCE TO RELATED APPLICATION

This application claims benefit of priority to Japanese Patent Application 2025-080015, filed May 12, 2025, the entire content of which is incorporated herein by reference.

### BACKGROUND

### Technical Field

The present disclosure relates to an electronic device and an imaging apparatus.

### Background Art

Power supplies compliant with the Power over Ethernet (PoE) standard are known as power sources for electronic devices. In more detail, the PoE standard consists of three standards: 802.3af (PoE), 802.3at (PoE+), and 802.3bt (PoE++). These three standards differ from one another in their power-supply capability. Specifically, the amount of power that can be supplied under the 802.3af (PoE) standard is up to 15.4 W. The amount of power that can be supplied under the 802.3at (PoE+) standard is up to 30W. The amount of power that can be supplied under the 802.3bt (PoE++) standard is up to 90W. With increasing functionality or performance requirements of electronic devices, it becomes necessary to replace power supply standards of the electronic devices with higher-level PoE standards.

Electronic devices capable of receiving power under a PoE standard have a power-receiving circuit compliant with the PoE standard. The higher the level of the PoE standard supported by the power-receiving circuit, the larger the circuit scale becomes.

JP2007-26083A discloses an information processing apparatus comprising a universal serial bus (USB) port, a network port, a power plug, an information storage unit, and a power control unit.

A host computer is connected to the USB port via a USB cable. The USB port receives 5V of power from the USB cable. A PoE-compatible network hub is connected to the network port via a network cable. The network port receives 48V of power from the network cable. The power plug receives 100V AC power.

The information storage unit stores power efficiency information. The power efficiency information includes information indicating a correspondence between the power consumption of the information processing apparatus and the power efficiency of the USB power supply, information indicating a correspondence between the power consumption of the information processing apparatus and the power efficiency of the PoE power supply, and information indicating a correspondence between the power consumption of the information processing apparatus and the power efficiency of the AC power supply.

The power control unit estimates the current power consumption of the information processing apparatus from its current operating status, and, based on the current power consumption of the information processing apparatus and the power efficiency information stored in the information storage unit, selects, from among USB power supply, PoE power supply, and AC power supply, the power supply that can supply the current power consumption of the information processing apparatus and has the highest power efficiency. As a result, a power supply with good power efficiency is selected, enabling power saving.

However, according to the technique disclosed in JP2007-26083A, power is supplied to the electronic device from only the selected single power supply system. Therefore, if it is necessary to incorporate a power-receiving circuit compliant with a higher PoE standard into the electronic device in order to accommodate the increased functionality or enhanced performance of the electronic device, the miniaturization of the electronic device is hindered.

### SUMMARY

The present disclosure provides an electronic device and an imaging apparatus.

An electronic device according to an aspect of the present disclosure comprises a load circuit to which power is supplied, a combining circuit, a first power-supply input terminal, a second power-supply input terminal, and a power-receiving circuit. The combining circuit has a first input terminal and a second input terminal, and outputs, to the load circuit, a combined power obtained by combining power input to the first input terminal and power input to the second input terminal. Power supplied to the first input terminal is input from a first power supply to the first power-supply input terminal. Power supplied to the second input terminal is input to the second power-supply input terminal from a second power supply different from the first power supply. The power-receiving circuit receives power input from the first power supply to the first power-supply input terminal. Power output from the power-receiving circuit is input to the first input terminal of the combining circuit. Standards for the first power supply include a first standard and a second standard capable of supplying a larger power than the first standard. The power-receiving circuit conforms to the first standard.

An imaging apparatus according to another aspect of the present disclosure is an imaging apparatus for capturing an image of a subject, comprising a load circuit to which power is supplied, a combining circuit, a first power-supply input terminal, a second power-supply input terminal, a power-receiving circuit, and a mode control circuit. The combining circuit has a first input terminal and a second input terminal, and outputs, to the load circuit, a combined power obtained by combining power input to the first input terminal and power input to the second input terminal. Power supplied to the first input terminal is input from a first power supply to the first power-supply input terminal. Power supplied to the second input terminal is input to the second power-supply input terminal from a second power supply different from the first power supply. The power-receiving circuit receives power input from the first power supply to the first power-supply input terminal. The mode control circuit causes an operation mode of the combining circuit to transition between a first operation mode and a second operation mode depending on a magnitude of a maximum power consumption of the load circuit. Power output from the power-receiving circuit is input to the first input terminal of the combining circuit. Standards for the first power supply include a first standard and a second standard capable of supplying a larger power than the first standard. The power-receiving circuit conforms to the first standard. The first operation mode is an operation mode in which power input to the first input terminal is output to the load circuit. The second operation mode is an operation mode in which the combined power is output to the load circuit.

### BRIEF DESCRIPTION OF DRAWINGS

FIG. 1 is a block diagram showing a configuration of a digital camera according to a first embodiment of the present disclosure.

FIG. 2 is a block diagram showing a configuration of a power supply circuit included in the digital camera according to the first embodiment of the present disclosure.

FIG. 3 shows an example of a configuration of a power-receiving circuit, an example of a configuration of a first switching circuit, and an example of a configuration of a second switching circuit included in the digital camera according to the first embodiment of the present disclosure.

FIG. 4 shows an example of a configuration of a combining circuit included in the digital camera according to the first embodiment of the present disclosure.

FIG. 5 is a time chart showing a first example of the operation of the power supply circuit included in the digital camera according to the first embodiment of the present disclosure.

FIG. 6 is a time chart showing a second example of the operation of the power supply circuit included in the digital camera according to the first embodiment of the present disclosure.

FIG. 7 is a time chart showing a third example of the operation of the power supply circuit included in the digital camera according to the first embodiment of the present disclosure.

FIG. 8 shows an example of operation mode setting information.

### DETAILED DESCRIPTION

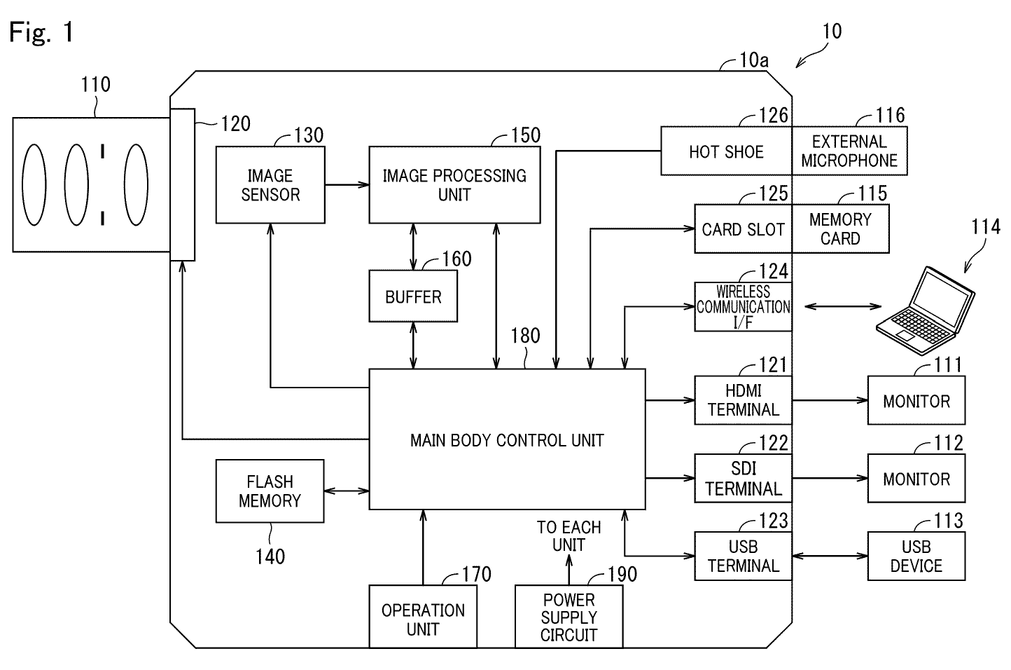

Embodiments of the electronic device and imaging apparatus of the present disclosure will now be described with reference to the drawings (FIGS. 1 - 8). However, the electronic device and imaging apparatus of this disclosure are not limited to the following embodiment and can be carried out in various manner without departing from the gist of the disclosure. In addition, explanations may be omitted where they would otherwise be repeated. Furthermore, in the figures, the same or corresponding parts are denoted by the same reference numerals and their explanations are not repeated.

### First Embodiment

A first embodiment of the present disclosure will be described with reference to FIGS. 1 - 8. In the first embodiment, a box-type digital camera 10 will be described as an example of an electronic device according to the present disclosure. The box-type digital camera 10 is an example of an "imaging apparatus". The box-type digital camera 10 captures an image of a subject.

### 1. Configuration

### 1-1. Configuration of Digital Camera

FIG. 1 is a block diagram showing a configuration of the digital camera 10 according to the first embodiment. As shown in FIG. 1, the box-type digital camera 10 has a box-shaped apparatus body 10a. The apparatus body 10a is configured to be connectable to various external devices.

Specifically, the digital camera 10 in the first embodiment is interchangeable-lens camera, and the apparatus body 10a is configured to accommodate interchangeable lenses 110. Furthermore, the apparatus body 10a is configured to be connectable to external devices such as an external monitor 111, an external monitor 112, a universal serial bus (USB) device 113, an information terminal 114, a memory card 115, and an external microphone 116. The power consumption of the digital camera 10 varies depending on the type of external device connected to the apparatus body 10a. Also, the power consumption of the digital camera 10 changes depending on the increase or decrease in the number of external devices connected to the apparatus body 10a.

In more detail, the digital camera 10 includes a mount 120 for an interchangeable lens 110, an image sensor 130, a flash memory 140, an image processing unit 150, a buffer memory 160, an operation unit 170, a main body control unit 180, and a power supply circuit 190. Furthermore, the digital camera 10 includes a first connection terminal 121, a second connection terminal 122, a third connection terminal 123, a wireless communication interface 124, a card slot 125, and a hot shoe 126. In the digital camera 10, the interchangeable lens 110, the mount 120, the mage sensor 130, the flash memory 140, the image processing unit 150, the buffer memory 160, the operation unit 170, the main body control unit 180, the first connection terminal 121, the second connection terminal 122, the third connection terminal 123, the wireless communication interface 124, the card slot 125, and the hot shoe 126 constitute a " load circuit 200 to which power is supplied".

The interchangeable lens 110 includes an optical system such as a zoom lens, a focus lens, and an aperture. The zoom lens changes the magnification of the subject image formed by the optical system. The focus lens changes the focus state of the subject image formed on the image sensor 130. The zoom lens and the focus lens are each composed of one or more lenses.

The interchangeable lens 110 further includes a drive unit. The drive unit of the interchangeable lens 110 includes a configuration for driving each part of the optical system, such as the focus lens. Specifically, the drive unit of the interchangeable lens 110 includes a DC motor, a stepping motor, a servo motor, or an ultrasonic motor. For example, the drive unit for the focus lens includes a motor that moves at least one of the one or more lenses of the focus lens along the optical axis of the optical system based on the control of the main body control unit 180.

The mount 120 is a mounting part for detachably attaching the interchangeable lens 110 to the apparatus body 10a. The mount 120 includes an interface circuit for data communication between the digital camera 10 and the interchangeable lens 110.

The image sensor 130 captures an image of a subject incident through the optical system of the interchangeable lens 110 and generates RAW data. The RAW data represents the captured image of the subject. The RAW data includes, for example, information on the amount of light exposed to each pixel in a Bayer array. The image sensor 130 performs, for example, the image capture operation of each frame that constitutes a video. The image sensor 130 is an example of an "imaging unit".

The image sensor 130 generates RAW data of a new frame at a predetermined frame rate (for example, 30 frames/second). The timing of RAW data generation and the operation of the electronic shutter are controlled by the main body control unit 180. Various image sensors such as CMOS image sensors, CCD image sensors, or NMOS image sensors can be used for the image sensor 130.

The image processing unit 150 generates image data by performing predetermined processing on the RAW data output from the image sensor 130. The image processing unit 150 may, for example, perform processing for development, or generate an image for display on the external monitor 111 or the like. The predetermined processing includes, but is not limited to, debayering, white balance correction, gamma correction, YC conversion, electronic zoom, compression, and decompression. The image processing unit 150 may be composed of hardwired electronic circuits, or it may be composed of a microcomputer or processor, etc.

The buffer memory 160 is a recording medium that functions as work memory for the image processing unit 150 and the main body control unit 180. The buffer memory 160 is composed of a dynamic random access memory (DRAM) or the like. The flash memory 140 is a non-volatile recording medium.

The operation unit 170 includes one or more operating members that receive operations (instructions) from the user. For example, the operation unit 170 includes buttons, levers, dials, or switches that receive operations from the user.

The main body control unit 180 controls the operation of the entire digital camera 10. Specifically, the main body control unit 180 includes one or more processors. The one or more processors perform various processes such as numerical calculations, information processing, and device control by executing computer programs (software). For example, the main body control unit 180 may include a central processing unit (CPU), a micro processing unit (MPU), a graphics processing unit (GPU), a digital signal processor (DSP), a field programmable gate array (FPGA), or an application specific integrated circuit (ASIC).

The first connection terminal 121, the second connection terminal 122, and the third connection terminal 123 are each used for data communication with external devices. In more detail, the first connection terminal 121, the second connection terminal 122, and the third connection terminal 123 have configurations that conform to different communication standards. In the first embodiment, the first connection terminal 121 is used for data communication conforming to the HDMI (registered trademark) standard. The second connection terminal 122 is used for data communication conforming to the serial digital interface (SDI) standard. The third connection terminal 123 is used for data communication conforming to the USB standard. Hereinafter, the first connection terminal 121 may be referred to as "HDMI terminal 121", the second connection terminal 122 may be referred to as "SDI terminal 122", and the third connection terminal 123 may be referred to as "USB terminal 123".

The HDMI terminal 121 is a connection terminal that connects to an external device via an HDMI cable. Specifically, the connector of an HDMI cable is connected to the HDMI terminal 121. The main body control unit 180 outputs a digital signal to the external device via the HDMI terminal 121. The digital signal includes a video signal. The digital signal may include both a video signal and an audio signal. The external device includes, for example, the external monitor 111.

The external monitor 111 displays video based on the video signal output from the HDMI terminal 121. For example, the external monitor 111 displays a live view image being captured in real time by the digital camera 10. The external monitor 111 may also display the settings menu screen of the digital camera 10, etc.

The SDI terminal 122 is a connection terminal that connects to an external device via an SDI cable. Specifically, the connector of the SDI cable is connected to the SDI terminal 122. The main body control unit 180 outputs a digital signal to the external device via the SDI terminal 122. The digital signal includes a video signal. The digital signal may also include a video signal and an audio signal. The external device includes, for example, the external monitor 112.

The external monitor 112 displays video based on the video signal output from the SDI terminal 122. For example, the external monitor 112 displays a live view image being captured in real time by the digital camera 10. The external monitor 112 may also display the settings menu screen of the digital camera 10, etc. A plurality of external monitors may be connected to the digital camera 10 simultaneously depending on the application.

The USB terminal 123 is a connection terminal for connecting to an external device such as the USB device 113. The USB terminal 123 may be connected directly to the external device or to the external device via a USB cable. The USB terminal 123 transmits and receives digital signals to and from the external device. Specifically, the main body control unit 180 outputs a digital signal including a video signal to the external device via the USB terminal 123. Alternatively, the main body control unit 180 outputs a digital signal including both a video signal and an audio signal to the external device via the USB terminal 123.

When the USB device 113 is connected to the USB terminal 123, the digital camera 10 operates as a host and supplies power to the USB device 113. External devices that operate using power supplied from the USB terminal 123 constitute the load circuit 200 of the digital camera 10. The USB device 113 includes, for example, storage media such as an HDD (Hard Disk Drive) or an SSD (Solid State Drive). The main body control unit 180 accesses the storage media via the USB terminal 123. The main body control unit 180 records various types of data, such as image data and audio data, to the storage media, and reads various types of data, such as image data and audio data, that are recorded on the storage media.

The wireless communication interface 124 performs wireless communication with external devices such as the information terminal 114. The wireless communication interface 124 includes a wireless communication circuit that performs wireless communication in accordance with a communication standard such as IEEE 802.11 or the Wi-Fi standard. The wireless communication interface 124 may perform wireless communication directly with external devices or via an access point. The wireless communication interface 124 may be connectable to a communication network such as the Internet. The wireless communication interface 124 is controlled by the main body control unit 180 and transmits a video signal to an external device in accordance with a predetermined wireless communication standard. Alternatively, the wireless communication interface 124 is controlled by the main body control unit 180 and transmits both a video signal and an audio signal to an external device in accordance with a predetermined wireless communication standard. The information terminal 114 includes a personal computer (PC) or a smartphone, etc.

The memory card 115 can be inserted into the card slot 125. The main body control unit 180 accesses the memory card 115 via the card slot 125. The main body control unit 180 records various data such as image data and audio data onto the memory card 115, and reads various data such as image data and audio data recorded on the memory card 115. The memory card 115 inserted into the card slot 125 constitutes the load circuit 200 of the digital camera 10.

Accessories are attached to the hot shoe 126. In more detail, the hot shoe 126 has one or more electronic contacts. The hot shoe 126 is electrically connected to the accessories attached to it. The accessories include a strobe, lighting, the external microphone 116, etc. The accessories attached to the hot shoe 126 constitute the load circuit 200 of the digital camera 10.

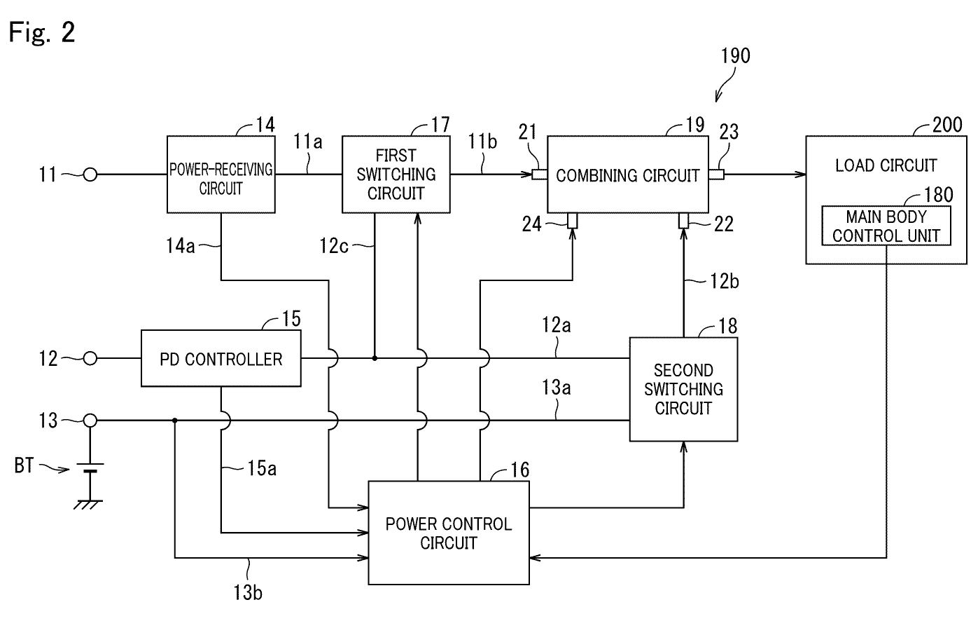

The power supply circuit 190 supplies power to the load circuit 200. The details of the power supply circuit 190 will be described below with reference to FIGS. 2 - 8.

### 1-2. Power Supply Circuit

First, the power supply circuit 190 will be described with reference to FIG. 2. FIG. 2 is a block diagram showing a configuration of the power supply circuit 190 included in the digital camera 10 according to the first embodiment. As shown in FIG. 2, the power supply circuit 190 supplies power to the load circuit 200. In more detail, the power supply circuit 190 includes a first power-supply input terminal 11, a second power-supply input terminal 12, a third power-supply input terminal 13, a power-receiving circuit 14, a PD controller 15, a power control circuit 16, a first switching circuit 17, a second switching circuit 18, a combining circuit 19, a first power line 11a, a second power line 11b, a third power line 12a, a fourth power line 12b, a fifth power line 13a, a sixth power line 12c, a first signal line 14a, a second signal line 15a, and a third signal line 13b.

The combining circuit 19 has a first input terminal 21, a second input terminal 22, an output terminal 23, and a connection terminal 24. The combining circuit 19 generates combined power by combining the power input to the first input terminal 21 and the power input to the second input terminal 22, and outputs the generated combined power to the load circuit 200 from the output terminal 23. In more detail, the combining circuit 19 outputs the combined power to the load circuit 200 when the power consumption of the load circuit 200 is greater than the power input to the first input terminal 21. The combining circuit 19 outputs the power input to the first input terminal 21 to the load circuit 200 when the power consumption of the load circuit 200 is less than the power input to the first input terminal 21.

Furthermore, when a battery BT is electrically connected to the second input terminal 22, the combining circuit 19 may output current from the second input terminal 22 so that the battery BT is charged when the power consumption of the load circuit 200 is less than the power input to the first input terminal 21. However, the combining circuit 19 is not required to output current to the battery BT from the second input terminal 22. In other words, the combining circuit 19 is not required to charge the battery BT.

In the first embodiment, the combining circuit 19 includes a USB charging IC. The first input terminal 21 is an input terminal for the USB charging IC that receives power supplied from a USB power device. The second input terminal 22 is an input terminal for the USB charging IC that receives power supplied from a battery BT. The USB power device includes a USB adapter and a USB mobile battery, etc.

In more detail, when the power consumption of the load circuit 200 is greater than the power supplied by the USB power device, the USB charging IC generates combined power by combining the power supplied by the USB power device and the power supplied by the battery BT and supplies the combined power to the load circuit 200. When the power consumption of the load circuit 200 is less than the power supplied by the USB power device, the USB charging IC charges the battery BT with the surplus power supplied by the USB power device.

The first power-supply input terminal 11 receives power from a first power supply to be supplied to the first input terminal 21 of the combining circuit 19. The specifications of the first power supply include two or more specifications. Specifically, the specifications of the first power supply include a first standard and a second standard that can supply more power than the first standard. In the first embodiment, the specifications of the first power supply include PoE (Power over Ethernet) specifications. Therefore, power conforming to the PoE standard is input to the first power-supply input terminal 11.

In more detail, the PoE standard includes three standards: 802.3af (PoE), 802.3at (PoE+), and 802.3bt (PoE++). These three standards have different power supply capacities. Specifically, the maximum amount of power that can be supplied based on the 802.3af (PoE) standard is 15.4W. The maximum amount of power that can be supplied based on the 802.3at (PoE+) standard is 30W. The maximum amount of power that can be supplied based on the 802.3bt (PoE++) standard is 90W.

In the first embodiment, power based on the PoE+ standard is input to the first power-supply input terminal 11. The PoE+ standard is an example of the "first standard", and the PoE++ standard is an example of the "second standard".

More specifically, a LAN (Local Area Network) cable is detachably connected to the first power-supply input terminal 11. The first power-supply input terminal 11 is connected to a PoE-compliant network hub via the LAN cable. The power of the PoE standard is transmitted by the LAN cable. In more detail, the LAN cable transmits a power-superimposed signal. Therefore, the first power-supply input terminal 11 receives a power-superimposed signal from the network hub. In the first embodiment, the PoE-compliant network hub functions as the first power supply. The voltage of the PoE standard is approximately 48V. The LAN cable is an example of a "communication cable".

The second power-supply input terminal 12 receives power supplied to the second input terminal 22 of the combining circuit 19 from a second power supply different from the first power supply. In the first embodiment, power supplied to the first input terminal 21 or the second input terminal 22 of the combining circuit 19 is input from the second power supply to the second power-supply input terminal 12. The voltage of the power supplied from the second power supply may be lower than the voltage of the power supplied from the first power supply.

In the first embodiment, the second power-supply input terminal 12 is connected to a DC power supply. In addition to the function of inputting power, the second power-supply input terminal 12 may further have the function of sending and receiving data signals with devices connected to the second power-supply input terminal 12. Specifically, in the first embodiment, the second power-supply input terminal 12 is a USB terminal and is connected to a USB power device. The USB power device is an example of a "second power supply". For example, a USB cable may be detachably connected to the second power-supply input terminal 12. In this case, the second power-supply input terminal 12 is connected to the USB power device via the USB cable. Alternatively, the USB power device may be directly and detachably connected to the second power-supply input terminal 12. The USB power device includes a USB adapter, a USB mobile battery, a USB host, etc. In the first embodiment, a USB adapter is connected to the second power-supply input terminal 12.

In more detail, the second power-supply input terminal 12 has a VBUS terminal, and power is input to the VBUS terminal. More specifically, in the first embodiment, the second power-supply input terminal 12 is a USB terminal corresponding to a Type-C connector. Therefore, power according to the USB_PD standard is input to the second power-supply input terminal 12. The power according to the USB_PD standard is, for example, 27W, which is about the same as the power of PoE+. In the first embodiment, the voltage input to the second power-supply input terminal 12 is approximately 9V.

The third power-supply input terminal 13 receives power supplied to the second input terminal 22 of the combining circuit 19 from a third power supply different from the first and second power sources. The voltage of the power supplied from the third power supply may be lower than the voltage of the power supplied from the first power supply. The voltage of the power supplied from the third power supply may be lower than the voltage of the power supplied from the second power supply. As power is supplied from the third power supply, the voltage output from the third power supply may decrease.

In the first embodiment, the third power-supply input terminal 13 is connected to a DC power supply. Specifically, in the first embodiment, the third power supply is a battery BT. The battery BT is detachably connected to the third power-supply input terminal 13. The battery BT may be a dry cell battery or a rechargeable battery. The maximum value of the battery voltage output from the battery BT is, for example, 8.4V. The battery voltage decreases as the remaining capacity of the battery BT decreases. The remaining capacity of the battery BT decreases as power is supplied from the battery BT.

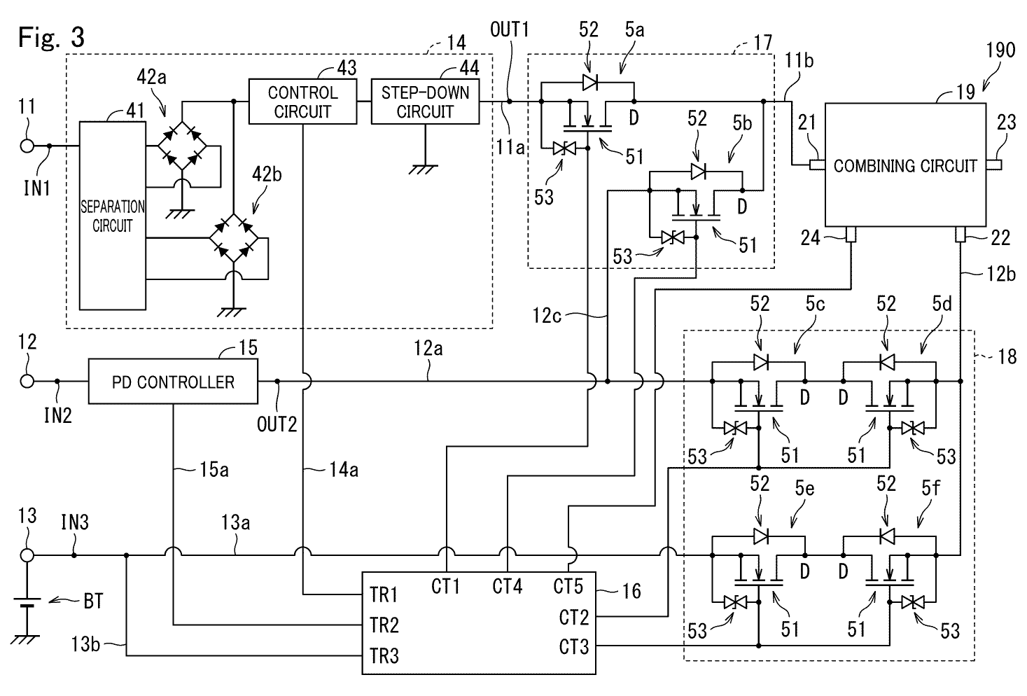

Although FIGS. 2 and 3 show the battery BT connected to the third power-supply input terminal 13, the battery BT is detachable from the third power-supply input terminal 13, and FIGS. 2 and 3 do not indicate that the battery BT is always connected to the third power-supply input terminal 13.

The power-receiving circuit 14 receives the power input to the first power-supply input terminal 11 and determines the standard of power input to the first power-supply input terminal 11. In the first embodiment, the power-receiving circuit 14 determines whether the standard of power input to the first power-supply input terminal 11 is 802.3af (PoE), 802.3at (PoE+), or 802.3bt (PoE++).

The first input terminal 21 of the combining circuit 19 receives power output from the power-receiving circuit 14. In more detail, the power-receiving circuit 14 steps down the voltage input to the first power-supply input terminal 11 and outputs it. Therefore, in the first embodiment, power conforming to the PoE standard, with the voltage stepped down, is input to the first input terminal 21.

The power-receiving circuit 14 further outputs a first detection signal in response to the connection of the first power supply to the first power-supply input terminal 11. The first detection signal is input to the power control circuit 16 via the first signal line 14a. The first detection signal may be, for example, a high-level signal. The first detection signal indicates that power is being supplied from the first power supply to the first power-supply input terminal 11. Alternatively, the first detection signal indicates that the first power supply is connected to the first power-supply input terminal 11.

In the first embodiment, the power-receiving circuit 14 has a configuration that conforms to the PoE+ standard. The power-receiving circuit conforming to the PoE+ standard has a smaller circuit size than the power-receiving circuit conforming to the PoE++ standard. For example, the circuit area of the power-receiving circuit conforming to the PoE++ standard is approximately twice that of the power-receiving circuit conforming to the PoE+ standard. As a result, the projected area of the apparatus body 10a with the power-receiving circuit conforming to the PoE++ standard implemented is approximately 1.5 times that of the apparatus body 10a with the power-receiving circuit conforming to the PoE+ standard implemented. Therefore, according to the first embodiment, the digital camera 10 can be made smaller compared to the case where a power-receiving circuit conforming to the PoE++ standard is implemented.

In the first embodiment, the power output from the power-receiving circuit 14 is input to the first input terminal 21 of the combining circuit 19 via the first switching circuit 17. In more detail, the power output from the power-receiving circuit 14 is input to the first input terminal 21 via the first power line 11a, the first switching circuit 17, and the second power line 11b in the mentioned order.

The PD controller 15 is a power-receiving circuit that receives power supplied from a USB power device. The circuit size of the PD controller 15 is smaller than that of a power-receiving circuit that receives power according to the PoE standard.

When a USB power device is connected to the second power-supply input terminal 12, the PD controller 15 determines whether the USB power device is a USB_PD standard device. When the USB power device is a USB_PD standard device, the PD controller 15 performs negotiation with the USB power device to supply power of a predetermined voltage and current from the USB power device.

The PD controller 15 further outputs a second detection signal in response to the USB power device being connected to the second power-supply input terminal 12. The second detection signal is input to the power control circuit 16 via the second signal line 15a. The second detection signal may be, for example, a high-level signal. The second detection signal indicates that power is being supplied from the second power supply to the second power-supply input terminal 12. Alternatively, the second detection signal indicates that the second power supply is connected to the second power-supply input terminal 12.

The power supplied from the USB power device to the second power-supply input terminal 12 is input to the second input terminal 22 of the combining circuit 19 via the PD controller 15 when the first power supply is connected to the first power-supply input terminal 11. In more detail, the power supplied from the USB power device to the second power-supply input terminal 12 is input to the second input terminal 22 via the PD controller 15, the third power line 12a, the second switching circuit 18, and the fourth power line 12b in the mentioned order.

Alternatively, when the first power supply is not connected to the first power-supply input terminal 11, the power supplied from the USB power device to the second power-supply input terminal 12 is input to the first input terminal 21 of the combining circuit 19. In more detail, the power supplied from the USB power device to the second power-supply input terminal 12 is input to the first input terminal 21 via the PD controller 15, the sixth power line 12c, the first switching circuit 17, and the second power line 11b in the mentioned order.

The fifth power line 13a transmits the power input from the battery BT to the third power-supply input terminal 13 to the second switching circuit 18. The third signal line 13b branches off from the fifth power line 13a and connects to the power control circuit 16.

When the battery BT is connected to the third power-supply input terminal 13 and power is supplied from the battery BT to the third power-supply input terminal 13, a third detection signal is input to the power control circuit 16 via the third signal line 13b. The third detection signal may be, for example, a high-level signal. The third detection signal indicates that power is being supplied from the third power supply to the third power-supply input terminal 13. Alternatively, the third detection signal indicates that the third power supply is connected to the third power-supply input terminal 13. A resistive voltage divider circuit may be interposed in the third signal line 13b.

The power input from battery BT to the third power-supply input terminal 13 is supplied to the second input terminal 22 of the combining circuit 19 when the second power supply is not connected to the second power-supply input terminal 12. In more detail, the power input from battery BT to the third power-supply input terminal 13 is input to the second input terminal 22 via the fifth power line 13a, the second switching circuit 18, and the fourth power line 12b in the mentioned order.

The first switching circuit 17 switches the supply source of power supplied to the first input terminal 21 of the combining circuit 19 between the first power-supply input terminal 11 and the second power-supply input terminal 12. The second switching circuit 18 switches the supply source of power supplied to the second input terminal 22 of the combining circuit 19 between the second power-supply input terminal 12 and the third power-supply input terminal 13.

In more detail, the sixth power line 12c branches off from the third power line 12a and is connected to the first switching circuit 17. The first switching circuit 17 switches the power line electrically connected to the second power line 11b between the first power line 11a and the sixth power line 12c. The second switching circuit 18 switches the power line electrically connected to the fourth power line 12b between the third power line 12a and the fifth power line 13a.

Specifically, when the first power supply (network hub) is connected to the first power-supply input terminal 11, the first switching circuit 17 is controlled by the power control circuit 16 to electrically connect the second power line 11b and the first power line 11a. As a result, the power output from the power-receiving circuit 14 is input to the first input terminal 21.

When power is supplied from the first power supply (network hub) to the first power-supply input terminal 11, and the second power supply (USB power device) is connected to the second power-supply input terminal 12, the second switching circuit 18 is controlled by the power control circuit 16 to electrically connect the fourth power line 12b and the third power line 12a. As a result, the power supplied from the USB power device to the second power-supply input terminal 12 is input to the second input terminal 22.

On the other hand, when power is supplied from the first power supply (network hub) to the first power-supply input terminal 11, and the third power supply (battery BT) is connected to the third power-supply input terminal 13, the second switching circuit 18 is controlled by the power control circuit 16 to electrically connect the fourth power line 12b and the fifth power line 13a. As a result, the power supplied from the battery BT to the third power-supply input terminal 13 is input to the second input terminal 22.

Furthermore, when the first power supply (network hub) is not connected to the first power-supply input terminal 11, and the second power supply (USB power device) is connected to the second power-supply input terminal 12, the first switching circuit 17 is controlled by the power control circuit 16 to electrically connect the second power line 11b and the sixth power line 12c. As a result, the power supplied from the USB power device to the second power-supply input terminal 12 is input to the first input terminal 21.

When the first power supply (network hub) is not connected to the first power-supply input terminal 11, and power is being supplied from the second power supply (USB power device) to the second power-supply input terminal 12, if the third power supply (battery BT) is connected to the third power-supply input terminal 13, the second switching circuit 18 is controlled by the power control circuit 16 to electrically connect the fourth power line 12b and the fifth power line 13a. As a result, the power supplied from the battery BT to the third power-supply input terminal 13 is input to the second input terminal 22.

The power control circuit 16 controls the first switching circuit 17 and the second switching circuit 18 based on the first detection signal, the second detection signal, and the third detection signal.

For example, when the first detection signal is output, the power control circuit 16 controls the first switching circuit 17 to electrically connect the first power line 11a and the second power line 11b, thereby supplying the power output from the power-receiving circuit 14 to the first input terminal 21 of the combining circuit 19. When the second detection signal is output after the first detection signal has been output, the power control circuit 16 controls the second switching circuit 18 to electrically connect the third power line 12a and the fourth power line 12b, thereby supplying the power output from the PD controller 15 to the second input terminal 22 of the combining circuit 19. On the other hand, when the third detection signal is output after the first detection signal has been output, the power control circuit 16 controls the second switching circuit 18 to electrically connect the fifth power line 13a and the fourth power line 12b, thereby supplying the power output from the battery BT to the second input terminal 22 of the combining circuit 19.

Furthermore, when the second detection signal is output while the first detection signal is not input to the power control circuit 16, the power control circuit 16 controls the first switching circuit 17 to electrically connect the sixth power line 12c and the second power line 11b. As a result, the power output from the PD controller 15 is supplied to the first input terminal 21 of the combining circuit 19. When the third detection signal is output after the second detection signal is output while the first detection signal is not input to the power control circuit 16, the power control circuit 16 controls the second switching circuit 18 to electrically connect the fifth power line 13a and the fourth power line 12b. As a result, the power output from the battery BT is supplied to the second input terminal 22 of the combining circuit 19.

Therefore, when power is input to the first power-supply input terminal 11 from the network hub (first power supply) and power is input to the second power-supply input terminal 12 from the USB power device (second power supply), the combining circuit 19 combines the power output from the power-receiving circuit 14, which receives power according to the PoE standard, and the power according to the USB_PD standard to generate combined power, and supplies the combined power to the load circuit 200.

When power is input to the first power-supply input terminal 11 from the network hub (first power supply) and power is input to the third power-supply input terminal 13 from the battery BT (third power supply), the combining circuit 19 combines the power output from the power-receiving circuit 14, which receives power according to the PoE standard, and the power output from the battery BT to generate combined power, and supplies the combined power to the load circuit 200.

In more detail, the combining circuit 19 outputs combined power to the load circuit 200 when the power consumption of the load circuit 200 is greater than the power output from the power-receiving circuit 14. When the power consumption of the load circuit 200 is less than the power output from the power-receiving circuit 14, the combining circuit 19 outputs the power output from the power-receiving circuit 14 to the load circuit 200. In other words, when a network hub is connected to the digital camera 10, the combining circuit 19 prioritizes outputting PoE standard power to the load circuit 200 over power supplied from the USB power device or battery BT.

Furthermore, the combining circuit 19 may output current from the second input terminal 22 so that the battery BT is charged by the surplus power when the power consumption of the load circuit 200 is less than the power output from the power-receiving circuit 14. However, the combining circuit 19 is not required to output current from the second input terminal 22. In other words, the combining circuit 19 is not required to charge the battery BT.

When power is input to the second power-supply input terminal 12 from the USB power device (second power supply) and power is input to the third power-supply input terminal 13 from the battery BT (third power supply), the combining circuit 19 combines the power according to the USB_PD standard and the power output from the battery BT to generate combined power, and supplies the combined power to the load circuit 200.

In more detail, the combining circuit 19 outputs combined power to the load circuit 200 when the power consumption of the load circuit 200 is greater than the power output from the PD controller 15. When the power consumption of the load circuit 200 is less than the power output from the PD controller 15, the combining circuit 19 outputs the power output from the PD controller 15 to the load circuit 200. In other words, when both a USB power device and a battery BT are connected to the digital camera 10, the combining circuit 19 prioritizes outputting, to the load circuit 200, the power supplied by the USB power device over the power supplied by the battery BT.

Furthermore, the combining circuit 19 may output current from the second input terminal 22 so that the battery BT is charged by the surplus power when the power consumption of the load circuit 200 is less than the power output from the PD controller 15. However, the combining circuit 19 is not required to output current from the second input terminal 22. In other words, the combining circuit 19 is not required to charge the battery BT.

Furthermore, in the first embodiment, the operation modes of the combining circuit 19 include a first operation mode and a second operation mode. The first operation mode is an operation mode in which the power input to the first input terminal 21 is output to the load circuit 200 from the output terminal 23. The second operation mode is an operation mode in which the combined power is output to the load circuit 200 from the output terminal 23. In more detail, the first operation mode is an operation mode in which the power supplied to the load circuit 200 is fixed to the power input to the first input terminal 21. The second operation mode is an operation mode in which the output of combined power is permitted when power is input to both the first input terminal 21 and the second input terminal 22 simultaneously. In other words, the second operation mode is an operation mode in which the power supplied to the load circuit 200 is not fixed to the power input to the first input terminal 21.

The power control circuit 16 transitions the operation mode of the combining circuit 19 between the first operation mode and the second operation mode according to the magnitude of the maximum power consumption of the load circuit 200. Alternatively, the power control circuit 16 sets the operation mode of the combining circuit 19 to either the first operation mode or the second operation mode according to the magnitude of the maximum power consumption of the load circuit 200. In the first embodiment, the power control circuit 16 is an example of a "mode control circuit".

Specifically, the power control circuit 16 transitions the operation mode of the combining circuit 19 from the second operation mode to the first operation mode when the maximum power consumption of the load circuit 200 changes from above a predetermined value to below the predetermined value. The power control circuit 16 transitions the operation mode of the combining circuit 19 from the first operation mode to the second operation mode when the maximum power consumption of the load circuit 200 changes from below the predetermined value to above the predetermined value. Alternatively, the power control circuit 16 sets the operation mode of the combining circuit 19 to the first operation mode when the maximum power consumption of the load circuit 200 changes from above the predetermined value to below the predetermined value. The power control circuit 16 sets the operation mode of the combining circuit 19 to the second operation mode when the maximum power consumption of the load circuit 200 changes from below the predetermined value to above the predetermined value.

By allowing the operation mode of the combining circuit 19 to transition between the first operation mode and the second operation mode, heat generation of the digital camera 10 (electronic device) can be suppressed compared to a configuration in which the supply of combined power to the load circuit 200 is always permitted. Furthermore, when the power supplied to the second input terminal 22 is power output from the battery BT or USB mobile battery, the decrease in the battery voltage of the battery BT or USB mobile battery can be suppressed compared to a configuration in which the supply of combined power to the load circuit 200 is always permitted. Therefore, the decrease in the remaining capacity of the battery BT or USB mobile battery can be suppressed.

Specifically, the current operation mode of the load circuit 200 is notified from the main body control unit 180 to the power control circuit 16. The current operation mode of the load circuit 200 corresponds to the current operating state of the apparatus body 10a. The communication method between the main body control unit 180 and the power control circuit 16 may be, for example, I2C communication. The operation mode of the load circuit 200 is changed by the user operating the operation unit 170 and setting an arbitrary menu via the setting menu screen. When the main body control unit 180 receives the menu setting, the main body control unit 180 notifies the power control circuit 16 of the current operation mode of the load circuit 200. The magnitude of the maximum power consumption of the load circuit 200 corresponds to the operation mode of the load circuit 200.

When the power control circuit 16 receives a notification indicating the current operation mode of the load circuit 200 from the main body control unit 180, the power control circuit 16 decides whether or not to transition the operation mode of the combining circuit 19 based on the current operation mode of the load circuit 200.

When the power control circuit 16 decides to change the operation mode of the combining circuit 19, the power control circuit 16 outputs a mode transition signal to the combining circuit 19 that causes the operation mode of the combining circuit 19 to change between the first operation mode and the second operation mode.

The mode transition signal is input to the connection terminal 24 of the combining circuit 19 from the power control circuit 16. When the mode transition signal is input to the connection terminal 24 of the combining circuit 19, the combining circuit 19 transitions its operation mode between the first operation mode and the second operation mode. The communication method between the power control circuit 16 and the combining circuit 19 may be, for example, I2C communication.

Alternatively, the power control circuit 16 may determine the operation mode of the combining circuit 19 based on the current operation mode of the load circuit 200 and output a mode setting signal to the combining circuit 19.

### 1-3. Power Receiving Circuit

Next, an example of a configuration of the power-receiving circuit 14 will be described with reference to FIG. 3. FIG. 3 is a diagram showing an example of a configuration of the power-receiving circuit 14, an example of a configuration of the first switching circuit 17, and an example of a configuration of the second switching circuit 18 included in the digital camera 10 according to the first embodiment.

As shown in FIG. 3, in the first embodiment, the power-receiving circuit 14 includes a separation circuit 41, two rectifier circuits 42a and 42b, a control circuit 43, and a step-down circuit 44.

The separation circuit 41 separates and outputs power from the signal received at the first power-supply input terminal 11 via the LAN cable. The separation circuit 41 is composed of, for example, a pulse transformer. Specifically, the LAN cable contains four pairs (eight) of signal lines. In the PoE standard, power is transmitted through two pairs of the four pairs of signal lines. The separation circuit 41 separates and outputs power from the signal received from each of the two pairs of signal lines.

The rectifier circuits 42a and 42b rectify the current output from the separation circuit 41. Specifically, one of the rectifier circuits 42a and 42b corresponds to one of the two pairs of signal lines, and the other of the rectifier circuits 42a and 42b corresponds to the other of the two pairs of signal lines. Each of the rectifier circuits 42a and 42b may be configured, for example, as a full-wave rectifier circuit.

The power rectified by the rectifier circuits 42a and 42b is combined and input to the control circuit 43. When power is input to the control circuit 43 from the rectifier circuits 42a and 42b, the control circuit 43 outputs the first detection signal as described with reference to FIG. 2.

The control circuit 43 may be composed of an integrated circuit, for example. For example, the control circuit 43 may have an integrated circuit such as a logic integrated circuit (IC), a field programmable gate array (FPGA), or an application specific integrated circuit (ASIC).

The step-down circuit 44 reduces the voltage of the power input to the first power-supply input terminal 11. The step-down circuit 44 can be configured, for example, by a step-down DC/DC converter. In the first embodiment, the output of the step-down circuit 44 is the output of the power-receiving circuit 14. That is, the output of the step-down circuit 44 is supplied to the first power line 11a.

In more detail, the power rectified by the rectifier circuits 42a and 42b is input to the step-down circuit 44 via the control circuit 43. The step-down circuit 44 steps down the voltage of the power input via the control circuit 43. In the first embodiment, power conforming to the PoE standard is input to the first power-supply input terminal 11. The voltage conforming to the PoE standard is approximately 48V. The step-down circuit 44 may step down the 48V voltage to a voltage that is, for example, greater than 9V and 12V or less. In the first embodiment, the step-down circuit 44 steps down the 48V voltage to 10V. The upper limit of the voltage input from the step-down circuit 44 to the combining circuit 19 may be a voltage that is less than or equal to the withstand voltage of the load circuit 200.

### 1-4. Power Control Circuit, First Switching Circuit, and Second Switching Circuit

Referring next to FIG. 3, the power control circuit 16, the first switching circuit 17, and the second switching circuit 18 will be described.

As shown in FIG. 3, the power control circuit 16 has three input terminals TR1, TR2, and TR3 and five output terminals CT1, CT2, CT3, CT4, and CT5. The power control circuit 16 may be configured by, for example, a microcontroller.

The first detection signal is input to the input terminal TR1 from the control circuit 43 of the power-receiving circuit 14 via the first signal line 14a. The second detection signal is input to the input terminal TR2 from the PD controller 15 via the second signal line 15a. The third detection signal is input to the input terminal TR3 via the third signal line 13b. The input terminals TR1, TR2, and TR3 may be tolerant terminals.

The output terminal CT1 outputs a signal to turn the first switch 5a (described later) on and off. The output terminal CT2 outputs a signal to turn the third switch 5c and fourth switch 5d (described later) on and off. The output terminal CT3 outputs a signal to turn the fifth switch 5e and sixth switch 5f (described later) on and off. The output terminal CT4 outputs a signal to turn the second switch 5b (described later) on and off. The output terminal CT5 outputs the mode transition signal. Alternatively, the output terminal CT5 may output the mode setting signal.

As shown in FIG. 3, the first switching circuit 17 may have a first switch 5a and a second switch 5b.

The first switch 5a and the second switch 5b each have an N-channel MOSFET 51 and a bidirectional Zener diode 53. The N-channel MOSFET 51 has a parasitic diode 52.

The anode of the parasitic diode 52 is electrically connected to the source of the N-channel MOSFET 51. The cathode of the parasitic diode 52 is electrically connected to the drain of the N-channel MOSFET 51.

One terminal of the bidirectional Zener diode 53 is electrically connected to the source of the N-channel MOSFET 51, and the other terminal of the bidirectional Zener diode 53 is electrically connected to the gate of the N-channel MOSFET 51.

The source of the N-channel MOSFET 51 included in the first switch 5a is electrically connected to the first power line 11a. The drain of the N-channel MOSFET 51 included in the first switch 5a is electrically connected to the second power line 11b.

On the other hand, the source of the N-channel MOSFET 51 included in the second switch 5b is electrically connected to the sixth power line 12c. The drain of the N-channel MOSFET 51 included in the second switch 5b is electrically connected to the second power line 11b, similar to the first switch 5a.

The power control circuit 16 controls the gate voltage of the N-channel MOSFET 51 included in the first switch 5a to turn the first switch 5a on and off. Specifically, when a high-level signal is output from the output terminal CT1 of the power control circuit 16, the N-channel MOSFET 51 of the first switch 5a turns on. As a result, the first switch 5a turns on. When a low-level signal is output from the output terminal CT1 of the power control circuit 16, the N-channel MOSFET 51 of the first switch 5a turns off. As a result, the first switch 5a turns off. Similarly, the power control circuit 16 controls the gate voltage of the N-channel MOSFET 51 included in the second switch 5b to turn the second switch 5b on and off.

In more detail, the power control circuit 16 outputs a high-level signal from either the output terminal CT1 or the output terminal CT4. Specifically, when the first detection signal is input to the input terminal TR1, the power control circuit 16 outputs an high-level signal from the output terminal CT1, thereby turning on the first switch 5a. As a result, the first power line Ana and the second power line 11b become electrically conductive, and the output of the power-receiving circuit 14 is input to the first input terminal 21 of the combining circuit 19. On the other hand, when the first detection signal is not input to the input terminal TR1, and the second detection signal is input to the input terminal TR2, the power control circuit 16 outputs a high-level signal from the output terminal CT4, thereby turning on the second switch 5b. As a result, the sixth power line 12c and the second power line 11b become electrically conductive, and the power supplied from the USB power device to the second power-supply input terminal 12 is input to the first input terminal 21 of the combining circuit 19.

As shown in FIG. 3, the second switching circuit 18 may include a third switch 5c, a fourth switch 5d, a fifth switch 5e, and a sixth switch 5f.

The third switch 5c, the fourth switch 5d, the fifth switch 5e, and the sixth switch 5f each have an N-channel MOSFET 51 and a bidirectional Zener diode 53, similar to the first switch 5a and the second switch 5b. The configurations of the third switch 5c, the fourth switch 5d, the fifth switch 5e, and the sixth switch 5f are the same as those of the first switch 5a and the second switch 5b, so their explanations are omitted.

The N-channel MOSFET 51 of the third switch 5c and the N-channel MOSFET 51 of the fourth switch 5d are connected back-to-back. Specifically, the drain terminals of the two N-channel MOSFETs 51 are connected in series. Similarly, the N-channel MOSFET 51 of the fifth switch 5e and the N-channel MOSFET 51 of the sixth switch 5f are connected back-to-back.

The source of the N-channel MOSFET 51 included in the third switch 5c is electrically connected to the third power line 12a. The source of the N-channel MOSFET 51 included in the fourth switch 5d is electrically connected to the fourth power line 12b.

On the other hand, the source of the N-channel MOSFET 51 included in the fifth switch 5e is electrically connected to the fifth power line 13a. The source of the N-channel MOSFET 51 included in the sixth switch 5f is electrically connected to the fourth power line 12b, similar to the fourth switch 5d.

The power control circuit 16 controls the gate voltage of the N-channel MOSFET 51 included in the third switch 5c and the gate voltage of the N-channel MOSFET 51 included in the fourth switch 5d, respectively, to turn the third switch 5c and the fourth switch 5d on and off. Specifically, when a high-level signal is output from the output terminal CT2 of the power control circuit 16, the N-channel MOSFET 51 in the third switch 5c and the N-channel MOSFET 51 in the fourth switch 5d turn on. As a result, the third switch 5c and the fourth switch 5d are turned on. When a low-level signal is output from the output terminal CT2 of the power control circuit 16, the N-channel MOSFET 51 in the third switch 5c and the N-channel MOSFET 51 in the fourth switch 5d turn off. As a result, the third switch 5c and the fourth switch 5d are turned off. Similarly, the power control circuit 16 controls the gate voltage of the N-channel MOSFET 51 included in the fifth switch 5e and the gate voltage of the N-channel MOSFET 51 included in the sixth switch 5f, respectively, to turn the fifth switch 5e and the sixth switch 5f on and off.

In more detail, the power control circuit 16 outputs a high-level signal from either output the terminal CT2 or the output terminal CT3.

Specifically, when the power control circuit 16 outputs a high-level signal from the output terminal CT1 and the second detection signal is input to the input terminal TR2, the power control circuit 16 outputs a high-level signal from the output terminal CT2, thereby turning on the third switch 5c and the fourth switch 5d. As a result, the third power line 12a and the fourth power line 12b become electrically conductive, and the power supplied from the USB power device to the second power-supply input terminal 12 is input to the second input terminal 22 of the combining circuit 19.

On the other hand, when the power control circuit 16 outputs a high-level signal from the output terminal CT1 or the output terminal CT4 and the third detection signal is input to the input terminal TR3, the power control circuit 16 outputs a high-level signal from the output terminal CT3, thereby turning on the fifth switch 5e and the sixth switch 5f. As a result, the fifth power line 13a and the fourth power line 12b become electrically conductive, and the power supplied from the battery BT to the third power-supply input terminal 13 is input to the second input terminal 22 of the combining circuit 19.

### 1-5. Combining Circuit

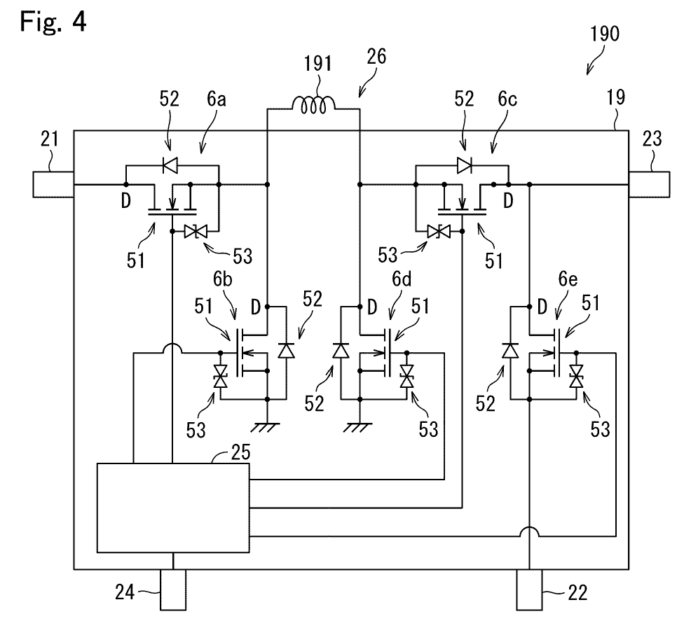

Next, an example of a configuration of the combining circuit 19 will be described with reference to FIG. 4. FIG. 4 is a diagram showing an example of a configuration of the combining circuit 19 included in the digital camera 10 according to the first embodiment. As shown in FIG. 4, in addition to the first input terminal 21, the second input terminal 22, the output terminal 23, and the connection terminal 24, the combining circuit 19 may also have a first switch 6a, a second switch 6b, a third switch 6c, a fourth switch 6d, a fifth switch 6e, and a control circuit 25. As shown in FIG. 4, the power supply circuit 190 may further include a coil 191 that is externally attached to the combining circuit 19.

The first switch 6a, the second switch 6b, the third switch 6c, the fourth switch 6d, and the fifth switch 6e each have an N-channel MOSFET 51 and a bidirectional Zener diode 53, similar to the first switch 5a and the second switch 5b shown in FIG. 3. The configurations of the first switch 6a, the second switch 6b, the third switch 6c, the fourth switch 6d, and the fifth switch 6e are the same as those of the first switch 5a and the second switch 5b shown in FIG. 3, so their explanations will be omitted.

The drain of the N-channel MOSFET 51 included in the first switch 6a is electrically connected to the first input terminal 21. The source of the N-channel MOSFET 51 included in the first switch 6a is electrically connected to one end of the coil 191.

The drain of the N-channel MOSFET 51 included in the second switch 6b is electrically connected to the source of the N-channel MOSFET 51 included in the first switch 6a and to the one end of the coil 191. The source of the N-channel MOSFET 51 included in the second switch 6b is electrically connected to the ground potential.

The drain of the N-channel MOSFET 51 included in the third switch 6c is electrically connected to the output terminal 23. The source of the N-channel MOSFET 51 included in the third switch 6c is electrically connected to the other end of the coil 191.

The drain of the N-channel MOSFET 51 included in the fourth switch 6d is electrically connected to the source of the N-channel MOSFET 51 included in the third switch 6c and to the other end of the coil 191. The source of the N-channel MOSFET 51 included in the fourth switch 6d is electrically connected to the ground potential.

The drain of the N-channel MOSFET 51 included in the fifth switch 6e is electrically connected to the output terminal 23. The source of the N-channel MOSFET 51 included in the fifth switch 6e is electrically connected to the second input terminal 22.

The control circuit 25 is composed of, for example, an integrated circuit. The control circuit 25 may have an integrated circuit such as a logic IC, a FPGA, or an ASIC.

The control circuit 25 controls the gate voltage of the N-channel MOSFET 51 included in each of the first switch 6a, the second switch 6b, the third switch 6c, the fourth switch 6d, and the fifth switch 6e to turn the first switch 6a, the second switch 6b, the third switch 6c, the fourth switch 6d, and the fifth switch 6e on and off, respectively.

In more detail, the first switch 6a, the second switch 6b, the third switch 6c, the fourth switch 6d, and the coil 191 constitute a DC/DC converter 26. The control circuit 25 adjusts the voltage supplied from the DC/DC converter 26 to the output terminal 23 by switching the first switch 6a, the second switch 6b, the third switch 6c, and the fourth switch 6d. In the first embodiment, the control circuit 25 steps down the voltage input to the first input terminal 21 and supplies it to the output terminal 23 by controlling the switching operation of each of the first switch 6a, the second switch 6b, the third switch 6c, and the fourth switch 6d, respectively. In other words, the control circuit 25 makes the output voltage output from the DC/DC converter 26 to the output terminal 23 a voltage smaller than the voltage input to the first input terminal 21. More specifically, the control circuit 25 adjusts the output voltage of the DC/DC converter 26 to a voltage smaller than the voltage of the power input to the first input terminal 21 and larger than the voltage of the power input to the second input terminal 22.

Furthermore, the control circuit 25 controls the fifth switch 6e to control the conductivity state between the second input terminal 22 and the output terminal 23.

In more detail, when the operation mode of the combining circuit 19 is set to the first operation mode, the control circuit 25 controls the gate voltage of the N-channel MOSFET 51 included in the fifth switch 6e to turn off the fifth switch 6e. As a result, the power supplied to the load circuit 200 is fixed to the power input to the first input terminal 21.

When the operation mode of the combining circuit 19 is set to the second operation mode and the power consumption of the load circuit 200 is greater than the power input to the first input terminal 21, the control circuit 25 controls the gate voltage of the N-channel MOSFET 51 included in the fifth switch 6e to turn on the fifth switch 6e. As a result, the combined power is output to the load circuit 200 from the output terminal 23. On the other hand, when the power consumption of the load circuit 200 is less than the power input to the first input terminal 21, the control circuit 25 turns off the fifth switch 6e. As a result, the power input to the first input terminal 21 is output to the load circuit 200 from the output terminal 23.

More specifically, an upper limit is set on the current output from the DC/DC converter 26 to the output terminal 23. When the power consumption of the load circuit 200 becomes greater than the power input to the first input terminal 21, the output current limit of the DC/DC converter 26 causes the voltage at the output terminal 23 to drop. When the voltage at the output terminal 23 becomes lower than the voltage at the second input terminal 22, current flows from the second input terminal 22 to the output terminal 23 via the parasitic diode 52 of the fifth switch 6e. When the control circuit 25 detects that the current value supplied from the second input terminal 22 to the output terminal 23 via the fifth switch 6e exceeds a predetermined value, the control circuit 25 turns on the fifth switch 6e.

According to the first embodiment, the combining circuit 19 supplies, to the output terminal 23, an output voltage that is obtained by stepping down the voltage of the power input to the first input terminal 21 and that is greater than the voltage of the power input to the second input terminal 22. In more detail, the control circuit 25 controls the DC/DC converter 26 to adjust the output voltage output from the DC/DC converter 26 to the output terminal 23 to be less than the voltage input to the first input terminal 21 and greater than the voltage input to the second input terminal 22. As a result, the problem of current flowing back to the second input terminal 22 when the fifth switch 6e is in the off state becomes less likely to occur. More specifically, the control circuit 25 makes the output voltage output from the DC/DC converter 26 to the output terminal 23 slightly greater than the voltage input to the second input terminal 22. For example, the control circuit 25 may control the DC/DC converter 26 so that the output voltage output from the DC/DC converter 26 to the output terminal 23 is 0.2V greater than the voltage input to the second input terminal 22.

In other words, because the voltage input to the first input terminal 21 is greater than the voltage input to the second input terminal 22, if the voltage input to the first input terminal 21 is supplied to the output terminal 23 without being stepped down, the potential difference between the output terminal 23 and the second input terminal 22 may exceed the breakdown voltage of the parasitic diode 52 of the fifth switch 6e. As a result, even when the fifth switch 6e is in the off state, the output current of the DC/DC converter 26 may flow back to the second input terminal 22 via the parasitic diode 52 of the fifth switch 6e. In contrast, according to the first embodiment, since the voltage input to the first input terminal 21 is stepped down and supplied to the output terminal 23, the potential difference between the output terminal 23 and the second input terminal 22 becomes smaller, making it less likely for the problem of current flowing back to the second input terminal 22 to occur. In particular, by stepping down the voltage input to the first input terminal 21 to a voltage slightly higher than the voltage input to the second input terminal 22 and supplying it to the output terminal 23, the problem of current flowing back to the second input terminal 22 becomes even less likely to occur. Therefore, for example, when the second input terminal 22 is electrically connected to the third power line 12a, the problem of current flowing back from the second input terminal 22 to the PD controller 15 becomes less likely to occur.

Furthermore, if the configuration is such that the voltage input to the first input terminal 21 is stepped down to a voltage lower than the voltage input to the second input terminal 22 and supplied to the output terminal 23, then even when the fifth switch 6e is in the off state, there is a possibility that the current input to the second input terminal 22 will be supplied to the output terminal 23 via the parasitic diode 52 of the fifth switch 6e. Therefore, in this case, there is a possibility that the power input to the second input terminal 22 will be output to the load circuit 200 with priority over the power input to the first input terminal 21. In contrast, according to the first embodiment, since the output voltage of the DC/DC converter 26 is greater than the voltage input to the second input terminal 22, the power input to the first input terminal 21 can be supplied to the load circuit 200 with priority over the power input to the second input terminal 22.

In the first embodiment, when power is supplied from the power-receiving circuit 14 to the first input terminal 21, the voltage input to the first input terminal 21 is 10V. Also, when power input from the USB power device to the second power-supply input terminal 12 is supplied to the second input terminal 22, the voltage input to the second input terminal 22 is 9V. When power is supplied from the power-receiving circuit 14 to the first input terminal 21 and power is supplied from the USB power device to the second input terminal 22, the control circuit 25 may control the switching operation of each of the first switch 6a, the second switch 6b, the third switch 6c and the fourth switch 6d to set the output voltage of the DC/DC converter 26 to, for example, 9.2V.

Furthermore, when power input from the battery BT to the second power-supply input terminal 12 is supplied to the second input terminal 22, the voltage input to the second input terminal 22 is a maximum of8.4V, and as the battery voltage output from the battery BT decreases, the voltage input to the second input terminal 22 also decreases. When power is supplied from the battery BT to the second input terminal 22, the control circuit 25 lowers the output voltage of the DC/DC converter 26 in accordance with a decrease in the battery voltage.

In more detail, the power supply circuit 190 further includes a battery voltage detection circuit (not shown). The battery voltage detection circuit detects the battery voltage output from the battery BT. The battery voltage indicates a voltage corresponding to the remaining capacity of the battery BT. The battery voltage detection circuit generates a detection signal indicating the detected battery voltage and outputs it to the power control circuit 16.

The power control circuit 16 sends a voltage setting signal to the control circuit 25 based on the detected battery voltage. The voltage setting signal is a signal that sets the output voltage of the DC/DC converter 26 to the voltage to be 0.2V higher than the detected battery voltage. The power control circuit 16 sets the output voltage of the DC/DC converter 26 to a lower value in response to a decrease in the detected battery voltage.

Based on the voltage setting signal, the control circuit 25 controls the first switch 6a, the second switch 6b, the third switch 6c, and the fourth switch 6d so that the output voltage of the DC/DC converter 26 is 0.2V higher than the battery voltage.

Furthermore, when the combining circuit 19 operates in the second operation mode, the control circuit 25 may control the gate voltage of the N-channel MOSFET 51 included in the fifth switch 6e according to the amount of power consumption of the load circuit 200, thereby adjusting the amount of current supplied from the second input terminal 22 to the output terminal 23.

### 2. Operation

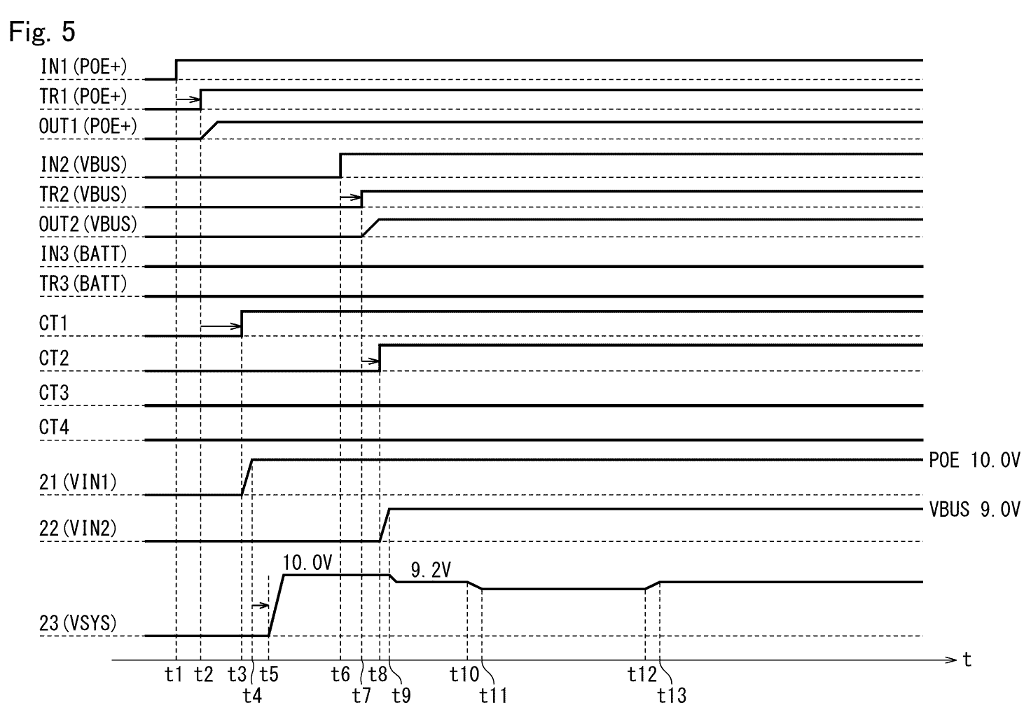

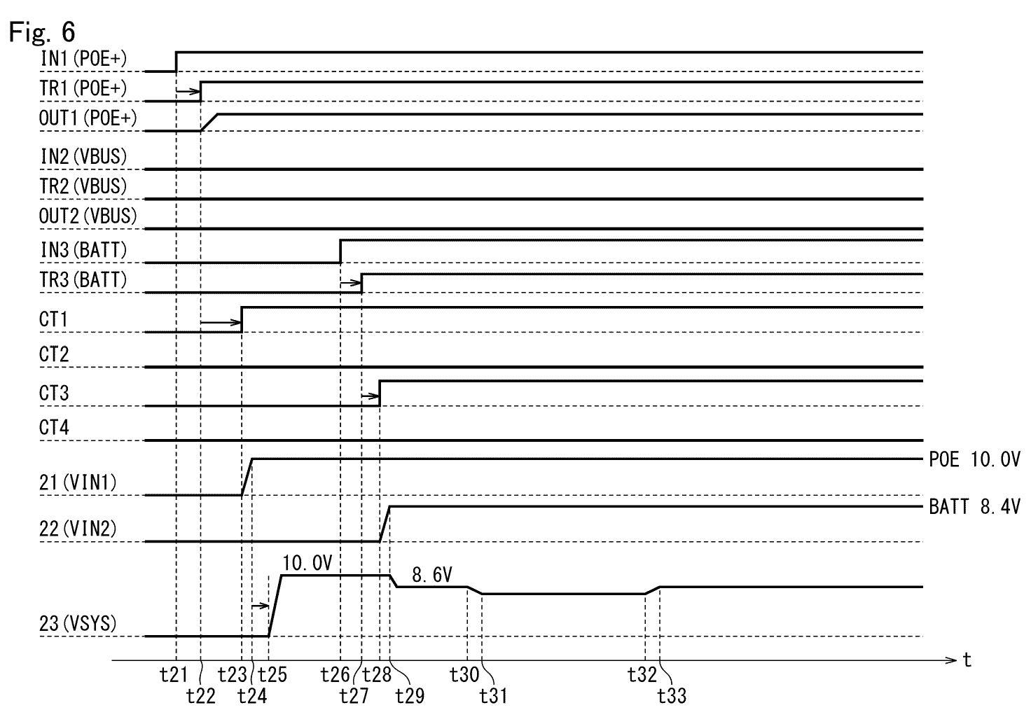

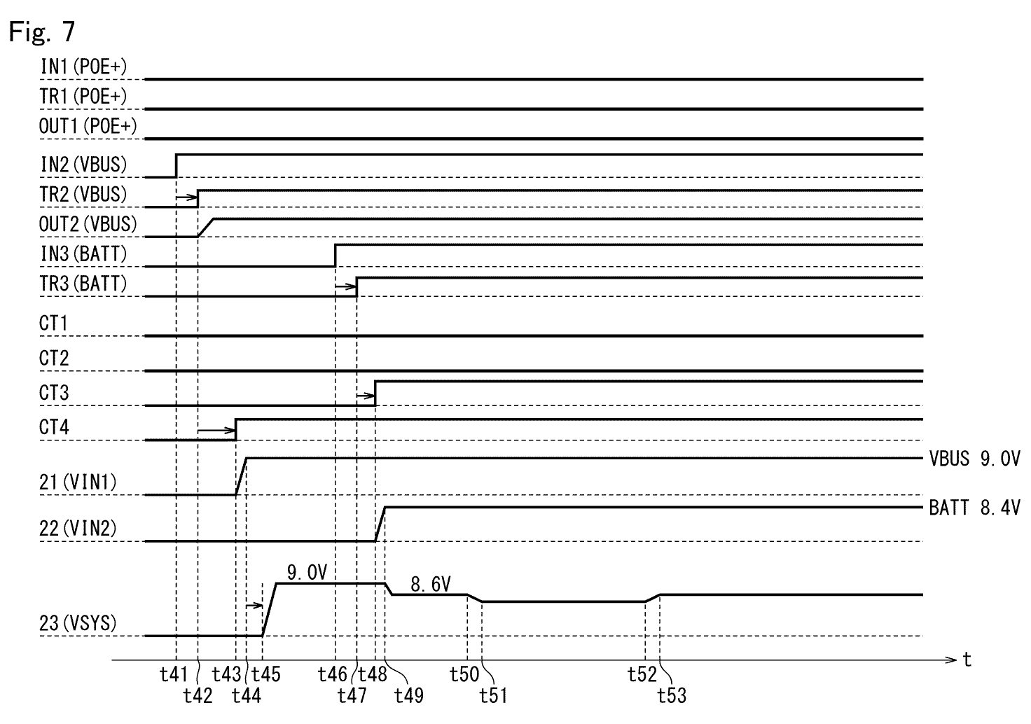

Next, an example of the operation of the power supply circuit 190 will be described with reference to FIGS. 3, 5, 6, and 7. FIG. 5 is a time chart showing a first example of the operation of the power supply circuit 190 included in the digital camera 10 according to the first embodiment. FIG. 6 is a time chart showing a second example of the operation of the power supply circuit 190 included in the digital camera 10 according to the first embodiment. FIG. 7 is a time chart showing a third example of the operation of the power supply circuit 190 included in the digital camera 10 according to the first embodiment. The horizontal axis in FIGS. 5, 6, and 7 represents time.

In more detail, FIGS. 5, 6, and 7 show the waveform of voltage IN1 input to the first power-supply input terminal 11 from the network hub (first power supply) via a LAN cable, the waveform of voltage input to the input terminal TR1 of the power control circuit 16, the waveform of voltage OUT1 output from the power-receiving circuit 14, the waveform of voltage IN2 input to the second power-supply input terminal 12 from the USB power device, the waveform of voltage input to the input terminal TR2 of the power control circuit 16, the waveform of voltage OUT2 output from the PD controller 15, the waveform of voltage IN3 input to the third power-supply input terminal 13 from the battery BT, the waveform of voltage input to the input terminal TR3 of the power control circuit 16, the waveforms of voltages output from the output terminals CT1, CT2, CT3 and CT4 of the power control circuit 16, the waveform of voltage VIN1 input to the first input terminal 21 of the combining circuit 19, the waveform of voltage VIN2 input to the second input terminal 22 of the combining circuit 19, and the waveform of voltage VSYS output from the output terminal 23 of the combining circuit 19.

First, a first example of the operation of the power supply circuit 190 will be described with reference to FIGS. 3 and 5. FIG. 5 shows the operation of generating combined power by combining the power of the PoE+ standard and the power input from the USB power device.

As shown in FIG. 5, when a PoE+ standard voltage IN1 (48V) is input to the first power-supply input terminal 11 (time t1), the control circuit 43 of the power-receiving circuit 14 outputs the first detection signal, and the step-down circuit 44 of the power-receiving circuit 14 outputs the voltage OUT1 (time t2). The first detection signal is a high-level signal and is input to the input terminal TR1 of the power control circuit 16 (time t2). In the first embodiment, the voltage OUT1 is 10V.

When the power-receiving circuit 14 outputs the voltage OUT1, the voltage is supplied to the power control circuit 16 and the combining circuit 19 via a power line (not shown) branching from the first power line 11a, and the power control circuit 16 and the combining circuit 19 perform startup process.

After the startup process of the power control circuit 16 is completed, the power control circuit 16 outputs a signal from the output terminal CT1 based on the first detection signal input to the input terminal TR1 (time t3), thereby turning on the first switch 5a included in the first switching circuit 17. As a result, the first power line 11a and the second power line 11b are electrically connected, and the voltage VIN1 (10V) is input from the power-receiving circuit 14 to the first input terminal 21 of the combining circuit 19 (time t4).

When the voltage VIN1 rises (time t4), the combining circuit 19 performs the startup process (from time t4 to time t5), and then controls the switching operation of each of the first switch 6a to the fourth switch 6d to output the voltage VSYS of 10V from the output terminal 23 (time t5).

Subsequently, as shown in FIG. 5, when the voltage IN2 is input from the USB power device (second power supply) to the VBUS terminal of the second power-supply input terminal 12 (time t6), the PD controller 15 outputs the second detection signal and also outputs the voltage OUT2 (time t7). The second detection signal is a high-level signal and is input to the input terminal TR2 of the power control circuit 16 (time t7). In the first embodiment, the voltage IN2 and the voltage OUT2 are 9V.

The power control circuit 16 outputs a signal from the output terminal CT2 based on the second detection signal input to the input terminal TR2 (time t8), thereby turning on the third switch 5c and the fourth switch 5d included in the second switching circuit 18. When the third switch 5c and the fourth switch 5d are turned on, the third power line 12a and the fourth power line 12b are electrically connected, and the voltage VIN2 (9V) is input from the PD controller 15 to the second input terminal 22 of the combining circuit 19 (time t9).

When the voltage VIN2 rises (time t9), the control circuit 25 of the combining circuit 19 controls the switching operation of each of the first switch 6a to the fourth switch 6d to reduce the voltage at the output terminal 23 to 9.2V, the voltage at the output terminal 23 being supplied from the drain of the N-channel MOSFET 51 included in the third switch 6c to the output terminal 23. As a result, the voltage VSYS is reduced to 9.2V.

In more detail, when the first detection signal and the second detection signal are input to the power control circuit 16, the power control circuit 16 transmits the voltage setting signal to the control circuit 25. The voltage setting signal is a signal that sets the voltage value of the voltage input from the third switch 6c to the output terminal 23. In other words, the voltage setting signal is a signal that sets the output voltage value of the DC/DC converter 26. Specifically, the power control circuit 16 sets a voltage that is slightly larger than the voltage input to the second input terminal 22 of the combining circuit 19. For example, the power control circuit 16 sets a voltage that is 0.2V larger than the voltage input to the second input terminal 22 of the combining circuit 19. In the first embodiment, 9.2V is set. As a result, the control circuit 25 of the combining circuit 19 controls the switching operation of each of the first switch 6a to the fourth switch 6d to step down the voltage at the output terminal 23 to the set voltage, the voltage at the output terminal 23 being supplied from the third switch 6c to the output terminal 23. As a result, the voltage VSYS output from the output terminal 23 is stepped down to the set voltage.

Subsequently, when the load on the load circuit 200 increases and the power consumption of the load circuit 200 becomes greater than the power input to the first input terminal 21 (time t10), the voltage VSYS at the output terminal 23 drops (time t11) because the upper limit of the output current of the DC/DC converter 26 is set. When the voltage VSYS at the output terminal 23 becomes less than the voltage at the second input terminal 22, current is supplied from the second input terminal 22 to the output terminal 23 via the parasitic diode 52 of the fifth switch 6e. The control circuit 25 turns on the fifth switch 6e when the current value supplied from the second input terminal 22 to the output terminal 23 via the fifth switch 6e exceeds a predetermined value. As a result, combined power is supplied from the output terminal 23 to the load circuit 200.

Due to the on-resistance component of the N-channel MOSFET 51 included in the fifth switch 6e, even when the fifth switch 6e is turned on, the voltage VSYS at the output terminal 23 remains lower than the voltage at the second input terminal 22. Therefore, the supply of combined power to the load circuit 200 is maintained.

Subsequently, when the load on the load circuit 200 decreases and the power consumption of the load circuit 200 becomes less than the power input to the first input terminal 21 (time t12), the current output from the output terminal 23 to the load circuit 200 becomes less than the upper limit of the output current of the DC/DC converter 26, and the voltage VSYS at the output terminal 23 increases to the set voltage (9.2V) (time t13). As a result, the voltage VSYS at the output terminal 23 becomes greater than the voltage at the second input terminal 22, and the supply of current from the second input terminal 22 to the output terminal 23 via the fifth switch 6e stops. When the supply of current from the second input terminal 22 to the output terminal 23 via the fifth switch 6e has stopped for a certain period of time, the control circuit 25 turns off the fifth switch 6e.

Next, a second example of the operation of the power supply circuit 190 will be described with reference to FIGS. 3 and 6. FIG. 6 shows the operation of generating combined power by combining the power according to the PoE+ standard and the power input from the battery BT.

The operation of the power supply circuit 190 at times t21, t22, t23, t24, and t25 in FIG. 6 is the same as the operation of the power supply circuit 190 at times t1, t2, t3, t4, and t5 in FIG. 5, and hence their explanations will be omitted.

As shown in FIG. 6, after the voltage VSYS (10V) is output from the output terminal 23 of the combining circuit 19 based on the power input from the first power-supply input terminal 11, when the voltage IN3 is input from the battery BT (third power supply) to the third power-supply input terminal 13 (time t26), the third detection signal is input to the input terminal TR3 of the power control circuit 16 (time t27). The third detection signal is a high-level signal. In the example shown in FIG. 6, the voltage IN3 is 8.4V.

The power control circuit 16 outputs a signal from the output terminal CT3 based on the third detection signal input to the input terminal TR3 (time t28), thereby turning on the fifth switch 5e and the sixth switch 5f included in the second switching circuit 18. When the fifth switch 5e and the sixth switch 5f are turned on, the fifth power line 13a and the fourth power line 12b are electrically connected, and the voltage VIN2 (8.4V) is input from the third power-supply input terminal 13 to the second input terminal 22 of the combining circuit 19 (time t29).

When the voltage VIN2 rises (time t29), the control circuit 25 of the combining circuit 19 controls the switching operation of each of the first switch 6a to the fourth switch 6d to step down the voltage input from the drain of the N-channel MOSFET 51 included in the third switch 6c to the output terminal 23. For example, when the voltage input to the second input terminal 22 is 8.4V, the control circuit 25 steps down the voltage at the output terminal 23 to 8.6V , the voltage at the output terminal 23 being supplied from the third switch 6c to the output terminal 23. As a result, the voltage VSYS is stepped down to 8.6V.

In more detail, when the first detection signal and the third detection signal are input to the power control circuit 16, the power control circuit 16 transmits a voltage setting signal to the control circuit 25, similar to when the first detection signal and the second detection signal are input to the power control circuit 16. Specifically, the power control circuit 16 sets a voltage slightly greater than the voltage input to the second input terminal 22 of the combining circuit 19, based on the detected battery voltage. In the example shown in FIG. 6, 8.6V is set. As a result, the control circuit 25 of the combining circuit 19 controls the switching operation of each of the first switch 6a to the fourth switch 6d to reduce the voltage at the output terminal 23 to the set voltage, the voltage at the output terminal 23 being supplied from the third switch 6c to the output terminal 23. As a result, the voltage VSYS output from the output terminal 23 is reduced to the set voltage.

The operation of the power supply circuit 190 at times t30, t31, and t32 in FIG. 6 is substantially the same as the operation of the power supply circuit 190 at times t10, t11, and t12 in FIG. 5, so their explanations are omitted.

When the second input terminal 22 is electrically connected to the battery BT, the load on the load circuit 200 decreases (time t32), and the voltage VSYS at the output terminal 23 increases (time t33), since the fifth switch 6e is in the ON state, a portion of the output current of the DC/DC converter 26 flows back to the second input terminal 22 via the fifth switch 6e, and the battery BT is charged.

When the current value of the current flowing in reverse from the fifth switch 6e to the second input terminal 22 reaches or exceeds a predetermined value, the control circuit 25 turns off the fifth switch 6e and stops charging the battery BT.

However, the control circuit 25 may allow charging of the battery BT. Specifically, when the current value of the current flowing in reverse from the fifth switch 6e to the second input terminal 22 exceeds a predetermined value, the control circuit 25 controls the gate voltage of the N-channel MOSFET 51 included in the fifth switch 6e to limit the current flowing in reverse from the fifth switch 6e to the second input terminal 22 while keeping the fifth switch 6e in the ON state, thereby charging the battery BT. Whether or not to allow charging of the battery BT is preset in the control circuit 25.

Next, a third example of the operation of the power supply circuit 190 will be described with reference to FIGS. 3 and 7. FIG. 7 shows the operation of generating combined power by combining the power input from the USB power device and the power input from the battery BT.

As shown in FIG. 7, when the USB_PD standard voltage IN2 (9V) is input to the second power-supply input terminal 12 from a USB power device (time t41), the PD controller 15 outputs the second detection signal and also outputs the voltage OUT2 (time t42). The second detection signal is input to the input terminal TR2 of the power control circuit 16 (time t42).

When the PD controller 15 outputs the voltage OUT2, the voltage is supplied to the power control circuit 16 and the combining circuit 19 via a power line (not shown) branching from the third power line 12a, causing the power control circuit 16 and the combining circuit 19 to perform startup process.

After the startup process of the power control circuit 16 is completed, the power control circuit 16 outputs a signal from the output terminal CT4 based on the second detection signal input to the input terminal TR2 (time t43), thereby turning on the second switch 5b included in the first switching circuit 17. As a result, the sixth power line 12c and the second power line 11b are electrically connected, and the voltage VIN1 (9V) is input from the PD controller 15 to the first input terminal 21 of the combining circuit 19 (time t44).

When the voltage VIN1 rises (time t44), the combining circuit 19 performs the startup process (from time t44 to time t45), and then controls the switching operation of each of the first switch 6a to the fourth switch 6d to output the voltage VSYS of 9V from the output terminal 23 (time t45).

Subsequently, when the voltage IN3 is input to the third power-supply input terminal 13 from the battery BT (third power supply) (time t46), the third detection signal is input to the input terminal TR3 of the power control circuit 16 (time t47). The operation of the power supply circuit 190 at times t47, t48, t49, t50, t51, t52 and t53 in FIG. 7 is substantially the same as the operation of the power supply circuit 190 at times t27, t28, t29, t30, t31, t32 and t33 in FIG. 6, so their explanations are omitted.

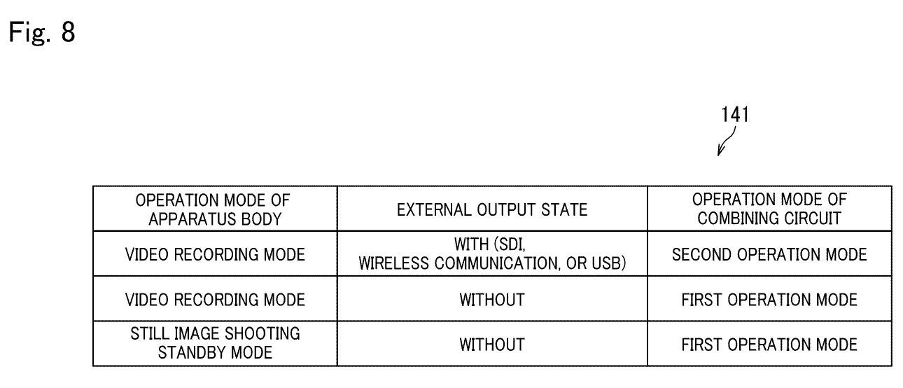

Referring next to FIG. 8, an operation of the power control circuit 16 in setting the operation mode of the combining circuit 19 will be described. FIG. 8 is a diagram showing an example of operation mode setting information 141. In the first embodiment, the power control circuit 16 sets the operation mode of the combining circuit 19 by referring to the operation mode setting information 141.

Specifically, the power control circuit 16 further includes a semiconductor memory (not shown). The semiconductor memory stores the operation mode setting information 141. For example, the power control circuit 16 may include at least one of a random access memory (RAM) and a read only memory (ROM). Alternatively, the power control circuit 16 may have, in place of or in addition to the RAM and ROM, at least one of a flash memory, an erasable programmable read only memory (EPROM), and an electrically erasable programmable read only memory (EEPROM). The operation mode setting information 141 may be, for example, a lookup table.

The operation mode setting information 141 shown in FIG. 8 associates the operation modes of the apparatus body 10a, external output states, and the operation modes of the combining circuit 19. The operation modes of the apparatus body 10a and the external output states correspond to the operation modes of the load circuit 200.

The operation modes of the apparatus body 10a include a video recording mode and a still image shooting standby mode. The still image shooting standby mode is an operation mode that generates a live view image. The operation modes of the apparatus body 10a can be set by the user operating the operation unit 170.

The external output states include a state in which an external output is present and a state in which no external output is present. The state in which an external output is present indicates that the digital camera 10 is performing data communication with an external device. The state in which no external output is present indicates that the digital camera 10 is not performing data communication with an external device. The state in which an external output is present includes, for example, at least one of a state in which data communication is taking place between the SDI terminal 122 and an external device, a state in which data communication is taking place between the wireless communication interface 124 and an external device, and a state in which data communication is taking place between the USB terminal 123 and the USB device 113. The operation mode for data communication with an external device can be set by the user operating the operation unit 170.

In the example shown in FIG. 8, the operation mode setting information 141 specifies that the operation mode of the combining circuit 19 is set to the second operation mode in a case where an external output is present in video recording mode, is set to the first operation mode in a case where no external output is present in video recording mode, and is set to the first operation mode in a case where no external output is present in still image shooting standby mode.

When the power control circuit 16 receives notification from the main body control unit 180 of the current operation mode of the load circuit 200, that is, when the power control circuit 16 receives notification of the current operation mode of the apparatus body 10a and the current state of the external output, the power control circuit 16 decides whether or not to transition the operation mode of the combining circuit 19 based on the current operation mode of the load circuit 200 and the operation mode setting information 141.

For example, when the operation mode of the load circuit 200 is set to the video recording mode and the mode for transmitting data to an external device, the power control circuit 16 sets the operation mode of the combining circuit 19 to the second operation mode. Specifically, when the combining circuit 19 is operating in the first operation mode and the current operation mode of the load circuit 200 notified by the main body control unit 180 indicates that video recording is performed while data communication with an external device is performed, the power control circuit 16 outputs to the combining circuit 19 a mode transition signal for transitioning the operation mode of the combining circuit 19 from the first operation mode to the second operation mode. Also, when the combining circuit 19 is operating in the second operation mode and the current operation mode of the load circuit 200 notified by the main body control unit 180 indicates that video recording is performed without data communication with an external device, the power control circuit 16 outputs to the combining circuit 19 a mode transition signal for transitioning the operation mode of the combining circuit 19 from the second operation mode to the first operation mode.

In the example shown in FIG. 8, the operation mode of the combining circuit 19 is transitioned between the first operation mode and the second operation mode depending on whether or not an external output is present in video recording mode. However, the conditions for transitioning the operation mode of the combining circuit 19 between the first operation mode and the second operation mode are not limited to whether or not an external output is present in video recording mode. For example, the power control circuit 16 may transition the operation mode of the combining circuit 19 between the first operation mode and the second operation mode depending on whether the operation mode of the apparatus body 10a is video recording mode or still image shooting standby mode. Alternatively, the power control circuit 16 may transition the operation mode of the combining circuit 19 between the first operation mode and the second operation mode depending on whether the operation mode of the apparatus body 10a is a high-load video recording mode or a low-load video recording mode. Here, the high-load video recording mode refers to a video recording mode in which the power consumption of the load circuit 200 is greater than that of the low-load video recording mode. For example, the high-load video recording mode may also be a video recording mode in which the power consumption of the image processing unit 150 is greater than that of the low-load video recording mode. Specifically, the high-load video recording mode may be an operation mode in which video is recorded at a frame rate equal to or higher than a predetermined frame rate (for example, 60 fps or higher), or an operation mode in which high-definition video such as 8K video is recorded. The low-load video recording mode may be an operation mode in which video is recorded at a frame rate lower than the predetermined frame rate (for example, lower than 60 fps), or an operation mode in which video having a lower image quality than that in the high-load video recording mode (for example, HD, FHD, or 4K) is recorded.

### 3. Variants

### First Variant

In the first embodiment, the second power supply is a USB power adapter, but the second power supply may be a USB mobile battery. In this case, as the voltage output from the USB mobile battery decreases, the voltage input to the second input terminal 22 decreases. Therefore, when supplying power to the second input terminal 22 from the USB mobile battery, the control circuit 25 may lower the output voltage of the DC/DC converter 26 in accordance with the decrease in the voltage input to the second input terminal 22, similar to when supplying power to the second input terminal 22 from a battery BT.

### Second Variant

In the first embodiment, the second power-supply input terminal 12 is a USB terminal, but the second power-supply input terminal 12 is not limited to a USB terminal. The second power-supply input terminal 12 may be, for example, a terminal connected to an AC adapter. An AC adapter is an example of a "second power supply". The AC adapter converts an AC voltage to a DC voltage and supplies it to the second power-supply input terminal 12.

### Third Variant

In the first embodiment, the second power-supply input terminal 12 is connected to a DC power supply, but the second power-supply input terminal 12 may be connected to an AC power supply. For example, the second power-supply input terminal 12 may be connected to a 100V AC commercial power supply. In this case, the power supply circuit 190 includes an AC/DC converter that converts an AC voltage to a DC voltage.

### 4. Overview

Embodiments of the present disclosure have been described above with reference to the drawings (FIGS. 1 - 8). For example, according to one embodiment of the present disclosure, the digital camera 10, which is a type of electronic device, includes the load circuit 200 to which power is supplied, the combining circuit 19, the first power-supply input terminal 11, the second power-supply input terminal 12, and the power-receiving circuit 14. The combining circuit 19 has the first input terminal 21 and the second input terminal 22. The combining circuit 19 outputs combined power to the load circuit 200. The combining circuit 19 obtains the combined power by combining the power input to the first input terminal 21 and the power input to the second input terminal 22. Power to be supplied to the first input terminal 21 is input to the first power-supply input terminal 11 from a first power supply. Power to be supplied to the second input terminal 22 is input to the second power-supply input terminal 12 from a second power supply different from the first power supply. The power-receiving circuit 14 receives power input from the first power supply to the first power-supply input terminal 11. The first input terminal 21 of the combining circuit 19 receives power output from the power-receiving circuit 14. The standards for the first power supply include a first standard and a second standard capable of supplying more power than the first standard. The power-receiving circuit 14 conforms to the first standard for the first power supply.

According to one embodiment of the present disclosure, power supplied from the first power supply and power supplied from the second power supply can be supplied to the load circuit 200 simultaneously. Therefore, even if the power consumption of the load circuit 200 increases due to the increased functionality or enhanced performance of the electronic device, the power necessary for the operation of the load circuit 200 can be supplied.

Furthermore, according to one embodiment of the present disclosure, it is possible to miniaturize the electronic device. Specifically, when using a single power supply system to accommodate the increased functionality or enhanced performance of electronic device, it is necessary to use a power supply with a large power supply capacity, but using a power supply with a large power supply capacity hinders the miniaturization of the device. In contrast, according to one embodiment of the present disclosure, it is possible to accommodate the increased functionality or enhanced performance of electronic device using two power supply systems. Thus, a power supply with a small power supply capacity can be used. Consequently, the electronic device can be made more compact.

In even more detail, according to one embodiment of the present disclosure, the combining circuit 19 outputs combined power to the load circuit 200 when the power consumption of the load circuit 200 is greater than the power input to the first input terminal 21. Therefore, when the power consumption of the load circuit 200 increases, the power necessary for the operation of the load circuit 200 can be supplied. Also, according to one embodiment of the present disclosure, the combining circuit 19 outputs the power input to the first input terminal 21 to the load circuit 200 when the power consumption of the load circuit 200 is less than the power input to the first input terminal 21. In other words, when the power consumption of the load circuit 200 is less than the power input to the first input terminal 21, the combining circuit 19 does not supply the power input to the second input terminal 22 to the load circuit 200. Therefore, since excess power is not supplied to the load circuit 200, heat generation of the load circuit 200 can be suppressed. Also, since excess power is not supplied to the load circuit 200, the consumption of unnecessary power can be suppressed.

Furthermore, according to one embodiment of the present disclosure, the combining circuit 19 further has the output terminal 23 that outputs power to the load circuit 200. The combining circuit 19 supplies an output voltage, which is a voltage obtained by stepping down the voltage of the power input to the first input terminal 21, to the output terminal 23. The output voltage is greater than the voltage of the power input to the second input terminal 22. Therefore, because the output voltage is less than the voltage of the power input to the first input terminal 21, it becomes less likely for a problem to occur in which current flows backward from the second input terminal 22 to the second power-supply input terminal 12. Also, because the output voltage is greater than the voltage of the power input to the second input terminal 22, when the power consumption of the load circuit 200 is small, the power input to the first input terminal 21 can be supplied to the load circuit 200 with priority over the power input to the second input terminal 22.

Furthermore, according to one embodiment of the present disclosure, the digital camera 10, which is a type of electronic device, may further include the third power-supply input terminal 13 to which power supplied to the second input terminal 22 is input from a third power supply different from the first and second power sources, the first switching circuit 17 that switches the supply source of power supplied to the first input terminal 21 between the first power-supply input terminal 11 and the second power-supply input terminal 12, and the second switching circuit 18 that switches the supply source of power supplied to the second input terminal 22 between the second power-supply input terminal 12 and the third power-supply input terminal 13. By further providing the digital camera 10 with the third power-supply input terminal 13, the first switching circuit 17, and the second switching circuit 18, it becomes possible to apply a combining circuit 19 having two input terminals (first input terminal 21 and second input terminal 22) to an electronic device that can be powered from three power sources.

Furthermore, according to one embodiment of the present disclosure, the power-receiving circuit 14 may have a smaller circuit size than a power-receiving circuit conforming to the second standard for the first power supply. According to one embodiment of the present disclosure, a power-receiving circuit conforming to the first standard that has a smaller circuit size than a power-receiving circuit conformingto the second standard can be provided in the electronic device. Thus, the electronic device can be made more compact.

Furthermore, according to one embodiment of the present disclosure, the combining circuit 19 may include a USB charging IC. According to one embodiment of the present disclosure, the combining circuit 19 can be configured using a USB charging IC.

Furthermore, according to one embodiment of the present disclosure, the combining circuit 19 has operation modes. The operation modes of the combining circuit 19 may include a first operation mode in which the power input to the first input terminal 21 is output to the load circuit 200, and a second operation mode in which the combined power is output to the load circuit 200. The digital camera 10, which is a type of electronic device, may further include a power control circuit 16 that functions as a mode control circuit. The power control circuit 16 may function as a mode control circuit and transition the operation mode of the combining circuit 19 between the first operation mode and the second operation mode depending on the magnitude of the maximum power consumption of the load circuit 200.

According to one embodiment of the present disclosure, the operation mode of the combining circuit 19 can be transitioned between a first operation mode and a second operation mode. Therefore, compared to a configuration in which the supply of combined power to the load circuit 200 is always permitted, heat generation of the electronic device can be suppressed. Furthermore, in a case in which the power supplied to the second input terminal 22 is power output from a battery BT or USB mobile battery, the decrease in the battery voltage of the battery BT or USB mobile battery can be suppressed compared to a configuration in which the supply of combined power to the load circuit 200 is always permitted. In consequence, the decrease in the remaining capacity of the battery BT or USB mobile battery can be suppressed.

Furthermore, according to one embodiment of the present disclosure, the power control circuit 16 may function as a mode control circuit and set the operation mode of the combining circuit 19 to a second operation mode when the operation mode of the load circuit 200 is set to an operation mode for data communication with an external device. When the operation mode of the load circuit 200 is set to an operation mode for data communication with an external device, the maximum power consumption of the load circuit 200 increases. In contrast, by setting the operation mode of the combining circuit 19 to a second operation mode, the power necessary for the operation of the load circuit 200 can be supplied even when the power consumption of the load circuit 200 increases to its maximum power consumption.

Furthermore, according to one embodiment of the present disclosure, the first power-supply input terminal 11 may receive a power-superimposed signal from the first power supply. According to one embodiment of the present disclosure, the electronic device can be powered by a power supply that provides power using a power-superimposed signal.

Furthermore, according to one embodiment of the present disclosure, the power-receiving circuit 14 may include the separation circuit 41 that separates power from the power-superimposed signal and outputs the power separated. According to one embodiment of the present disclosure, the electronic device can supply the power separated from the signal to the load circuit 200.

Furthermore, according to one embodiment of the present disclosure, the power-receiving circuit 14 may further include the rectifier circuits 42a and 42b that rectify the power output from the separation circuit 41. According to one embodiment of the present disclosure, the electronic device can rectify the power output from the separation circuit 41 and supply it to the load circuit 200.

Furthermore, according to one embodiment of the present disclosure, the power-receiving circuit 14 may include the step-down circuit 44 that steps down the voltage of the power input to the first power-supply input terminal 11. According to one embodiment of the present disclosure, even if the voltage of the first power supply is greater than the withstand voltage of the load circuit 200, the voltage input to the first power-supply input terminal 11 can be stepped down by the step-down circuit 44 to supply, to the load circuit 200, a voltage that is less than or equal to the withstand voltage of the load circuit 200.

Furthermore, according to one embodiment of the present disclosure, the standards for the first power supply may include a Power over Ethernet (PoE) standard. According to one embodiment of the present disclosure, a PoE standard power supply can be used as the power supply for an electronic device.

Furthermore, according to one embodiment of the present disclosure, the second power supply may include a DC power supply or an AC power supply. According to one embodiment of the present disclosure, a DC power supply or an AC power supply can be used as the power supply for an electronic device. Specifically, a USB power supply, an AC adapter, a commercial AC power supply, etc., can be used as the power supply for an electronic device. USB power supplies include USB adapters, USB mobile batteries, USB host devices, etc.

Furthermore, according to one embodiment of the present disclosure, the second power supply may include a USB power supply or an AC adapter. According to one embodiment of the present disclosure, a USB power supply or an AC adapter can be used as the power supply for an electronic device.

Furthermore, according to one embodiment of the present disclosure, the digital camera 10, which is a type of imaging apparatus, captures an image of a subject. The digital camera 10, which is a type of imaging apparatus, includes the load circuit 200 to which power is supplied, the combining circuit 19, the first power-supply input terminal 11, the second power-supply input terminal 12, the power-receiving circuit 14, and the power control circuit 16. The combining circuit 19 has the first input terminal 21 and the second input terminal 22. The combining circuit 19 outputs combined power to the load circuit 200. The combining circuit 19 obtains the combined power by combining the power input to the first input terminal 21 and the power input to the second input terminal 22. Power to be supplied to the first input terminal 21 is input to the first power-supply input terminal 11 from a first power supply. Power to be supplied to the second input terminal 22 is input to the second power-supply input terminal 12 from a second power supply different from the first power supply. The power-receiving circuit 14 receives power input from the first power supply to the first power-supply input terminal 11. The power control circuit 16 functions as a mode control circuit and transitions the operation mode of the combining circuit 19 between a first operation mode and a second operation mode according to the magnitude of the maximum power consumption of the load circuit 200. Power output from the power-receiving circuit 14 is input to the first input terminal 21 of the combining circuit 19. The standards for the first power supply include a first standard and a second standard that can supply more power than the first standard. The power-receiving circuit 14 conforms to the first standard for the first power supply. The first operation mode of the combining circuit 19 is an operation mode in which the power input to the first input terminal 21 is output to the load circuit 200. The second operation mode of the combining circuit 19 is an operation mode in which the combined power is output to the load circuit 200.

According to one embodiment of the present disclosure, power supplied from the first power supply and power supplied from the second power supply can be supplied to the load circuit 200 simultaneously. Therefore, even if the power consumption of the load circuit 200 increases due to the increased functionality or enhanced performance of the imaging apparatus, the power necessary for the operation of the load circuit 200 can be supplied.

Furthermore, according to one embodiment of the present disclosure, it is possible to miniaturize the imaging apparatus. Specifically, when using a single power supply system to accommodate the increased functionality or enhanced performance of the imaging apparatus, it is necessary to use a power supply with a large power supply capacity, but using a power supply with a large power supply capacity hinders the miniaturization of the imaging apparatus. In contrast, according to one embodiment of the present disclosure, the increased functionality or enhanced performance of the imaging apparatus can be accommodated using two power supply systems. Therefore, a power supply with a small power supply capacity can be used. Consequently, the imaging apparatus can be made more compact.

Furthermore, the operation mode of the combining circuit 19 can be transitioned between the first operation mode and the second operation mode. Therefore, compared to a configuration in which the supply of combined power to the load circuit 200 is always permitted, heat generation of the imaging apparatus can be suppressed. Also, in a case in which the power supplied to the second input terminal 22 is power output from a battery BT or USB mobile battery, the decrease in the battery voltage of the battery BT or USB mobile battery can be suppressed compared to a configuration in which the supply of combined power to the load circuit 200 is always permitted. Therefore, the decrease in the remaining capacity of the battery BT or USB mobile battery can be suppressed.

The present disclosure is not limited to the embodiments described above, and can be carried out in various forms without departing from its essence. Furthermore, the components disclosed in the embodiment can be modified as appropriate. For example, a certain one of all the components shown in one embodiment may be added to the components of another embodiment, or some of all the components shown in one embodiment may be removed from the embodiment.

The drawings schematically illustrate each component for ease of understanding, and the thickness, length, number, spacing, and the like of the illustrated components may differ from those in actual implementations due to drawing conventions. Furthermore, the configuration of each component shown in the above embodiment is merely an example and is not particularly limitative, and it is natural that various modifications are possible within the scope that does not substantially deviate from the effects of this disclosure.

For example, in the embodiment described with reference to FIGS. 1 - 8, the digital camera 10 is equipped with the first power-supply input terminal 11, the second power-supply input terminal 12, and the third power-supply input terminal 13, but the third power-supply input terminal 13 may be omitted. In this case, the first switching circuit 17 and the second switching circuit 18 may be omitted.

Furthermore, in the embodiment described with reference to FIGS. 1 - 8, the digital camera 10 was equipped with three power input terminals (first power-supply input terminal 11, second power-supply input terminal 12, and third power-supply input terminal 13), but the digital camera 10 may be equipped with four or more power-supply input terminals. In other words, in the embodiment described with reference to FIGS. 1 - 8, the digital camera 10 is configured to be able to receive power from three power sources, but the digital camera 10 may be configured to be able to receive power from four or more power sources.

Furthermore, in the embodiment described with reference to FIGS. 1 - 8, power based on the 802.3at (PoE+) standard is input to the first power-supply input terminal 11, but power based on the 802.3af (PoE) standard may also be input to the first power-supply input terminal 11.

Furthermore, in the embodiment described with reference to FIGS. 1 - 8, the digital camera 10 does not have a display, but the digital camera 10 may have a display.

Furthermore, in the embodiment described with reference to FIGS. 1 - 8, the digital camera 10 is equipped with the second power-supply input terminal 12 connected to a USB power device and the third connection terminal 123 connected to the USB device 113, but the digital camera 10 may have only one USB terminal.

### NOTES

The present disclosure further discloses the following aspects, which are not intended to limit the present disclosure.

### Aspect 1

An electronic device, comprising:
a load circuit to which power is supplied;
a combining circuit having a first input terminal and a second input terminal, the combining circuit outputting, to the load circuit, a combined power obtained by combining power input to the first input terminal and power input to the second input terminal;
a first power-supply input terminal into which power supplied to the first input terminal is input from a first power supply;
a second power-supply input terminal into which power supplied to the second input terminal is input from a second power supply different from the first power supply; and
a power-receiving circuit configured to receive power input from the first power supply to the first power-supply input terminal, wherein power output from the power-receiving circuit is input to the first input terminal of the combining circuit,
standards for the first power supply include a first standard and a second standard capable of supplying a larger power than the first standard, the power-receiving circuit conforms to the first standard.

### Aspect 2

The electronic device according to aspect 1, wherein
the combining circuit further has an output terminal for outputting power to the load circuit,
the combining circuit supplies, to the output terminal, an output voltage obtained by stepping down the voltage of power input to the first input terminal,
the output voltage is higher than a voltage of the power input to the second input terminal.

### Aspect 3

The electronic device according to aspect 1 or 2, further comprising:
a third power-supply input terminal into which power supplied to the second input terminal is input from a third power supply different from the first power supply and the second power supply;
a first switching circuit configured to switch a supply source of power supplied to the first input terminal between the first power-supply input terminal and the second power-supply input terminal; and
a second switching circuit configured to switch a supply source of power supplied to the second input terminal between the second power-supply input terminal and the third power-supply input terminal.

### Aspect 4

The electronic device according to any one of aspects 1 to 3,
wherein the power-receiving circuit conforming to the first standard has a smaller circuit scale than a power-receiving circuit conforming to the second standard.

### Aspect 5

The electronic device according to any one of aspects 1 to 4, wherein
the combining circuit includes a USB charging IC.

### Aspect 6

The electronic device according to any one of aspects 1 to 5, wherein
the combining circuit has operation modes, the operation modes include:
   a first operation mode in which power input to the first input terminal is output to the load circuit; and
   a second operation mode in which the combined power is output to the load circuit,
   the electronic device further comprising
      a mode control circuit configured to cause an operation mode of the combining circuit to transition between the first operation mode and the second operation mode depending on a magnitude of a maximum power consumption of the load circuit.

### Aspect 7

The electronic device according to aspect 6, wherein
the mode control circuit sets the operation mode of the combining circuit to the second operation mode when the operation mode of the load circuit is set to an operation mode for data communication with an external device.

### Aspect 8

The electronic device according to any one of aspects 1 to 7, wherein
the first power-supply input terminal receives a power-superimposed signal from the first power supply.

### Aspect 9

The electronic device according to aspect 8, wherein
the power-receiving circuit includes a separation circuit configured to separate power from the power-superimposed signal and output the power separated.

### Aspect 10

The electronic device according to aspect 9,
wherein the power-receiving circuit further includes a rectifier circuit configured to rectify the power output from the separation circuit.

### Aspect 11

The electronic device according to any one of aspects 1 to 10, wherein
the power-receiving circuit includes a step-down circuit configured to step down a voltage of the power input to the first power-supply input terminal.

### Aspect 12

The electronic device according to any one of aspects 1 to 11, wherein
the standards for the first power supply include a Power over Ethernet (PoE) standard.

### Aspect 13

The electronic device according to any one of aspects 1 to 12, wherein
the second power supply includes a DC power supply or an AC power supply.

### Aspect 14

The electronic device according to any one of aspects 1 to 13, wherein
the second power supply includes a USB power supply or an AC adapter.

### Aspect 15

An imaging apparatus for capturing an image of a subject, comprising:
a load circuit to which power is supplied;
a combining circuit having a first input terminal and a second input terminal, the combining circuit outputting a combined power obtained by combining power input to the first input terminal and power input to the second input terminal to the load circuit;
a first power-supply input terminal into which power supplied to the first input terminal is input from a first power supply;
a second power-supply input terminal into which power supplied to the second input terminal is input from a second power supply different from the first power supply;
a power-receiving circuit configured to receive power input from the first power supply to the first power-supply input terminal; and
a mode control circuit configured to cause an operation mode of the combining circuit to transition between a first operation mode and a second operation mode depending on a magnitude of a maximum power consumption of the load circuit, wherein
power output from the power-receiving circuit is input to the first input terminal of the combining circuit,
standards for the first power supply includes a first standard and a second standard capable of supplying a larger power than the first standard,
the power-receiving circuit conforms to the first standard,
the first operation mode is an operation mode in which power input to the first input terminal is output to the load circuit,
the second operation mode is an operation mode in which the combined power is output to the load circuit.

The present disclosure is applicable to an electronic device and an imaging apparatus that can be powered from a plurality of power supply systems.

What is claimed is:

1. An electronic device, comprising:
a load circuit to which power is supplied;
a combining circuit having a first input terminal and a second input terminal, the combining circuit outputting, to the load circuit, a combined power obtained by combining power input to the first input terminal and power input to the second input terminal;
a first power-supply input terminal into which power supplied to the first input terminal is input from a first power supply;
a second power-supply input terminal into which power supplied to the second input terminal is input from a second power supply different from the first power supply; and
a power-receiving circuit configured to receive power input from the first power supply to the first power-supply input terminal, wherein
power output from the power-receiving circuit is input to the first input terminal of the combining circuit,
standards for the first power supply include a first standard and a second standard capable of supplying a larger power than the first standard,
the power-receiving circuit conforms to the first standard.

2. The electronic device according to claim 1, wherein
the combining circuit further has an output terminal for outputting power to the load circuit,
the combining circuit supplies, to the output terminal, an output voltage obtained by stepping down the voltage of power input to the first input terminal,
the output voltage is higher than a voltage of the power input to the second input terminal.

3. The electronic device according to claim 1, further comprising:
a third power-supply input terminal into which power supplied to the second input terminal is input from a third power supply different from the first power supply and the second power supply;
a first switching circuit configured to switch a supply source of power supplied to the first input terminal between the first power-supply input terminal and the second power-supply input terminal; and
a second switching circuit configured to switch a supply source of power supplied to the second input terminal between the second power-supply input terminal and the third power-supply input terminal.

4. The electronic device according to claim 1, wherein
the power-receiving circuit conforming to the first standard has a smaller circuit scale than a power-receiving circuit conforming to the second standard.

5. The electronic device according to claim 1, wherein
the combining circuit includes a USB charging IC.

6. The electronic device according to claim 1, wherein
the combining circuit has operation modes,
the operation modes include:
a first operation mode in which power input to the first input terminal is output to the load circuit; and
a second operation mode in which the combined power is output to the load circuit,
the electronic device further comprising
a mode control circuit configured to cause an operation mode of the combining circuit to transition between the first operation mode and the second operation mode depending on a magnitude of a maximum power consumption of the load circuit.

7. The electronic device according to claim 6, wherein
the mode control circuit sets the operation mode of the combining circuit to the second operation mode when the operation mode of the load circuit is set to an operation mode for data communication with an external device.

8. The electronic device according to claim 1, wherein
the first power-supply input terminal receives a power-superimposed signal from the first power supply.

9. The electronic device according to claim 8, wherein
the power-receiving circuit includes a separation circuit configured to separate power from the power-superimposed signal and output the power separated.

10. The electronic device according to claim 9, wherein
the power-receiving circuit further includes a rectifier circuit configured to rectify the power output from the separation circuit.

11. The electronic device according to claim 1, wherein
the power-receiving circuit includes a step-down circuit configured to step down a voltage of the power input to the first power-supply input terminal.

12. The electronic device according to claim 1, wherein
the standards for the first power supply include a Power over Ethernet (PoE) standard.

13. The electronic device according to claim 1, wherein
the second power supply includes a DC power supply or an AC power supply.

14. The electronic device according to claim 1, wherein
the second power supply includes a USB power supply or an AC adapter.

15. An imaging apparatus for capturing an image of a subject, comprising:
a load circuit to which power is supplied;
a combining circuit having a first input terminal and a second input terminal, the combining circuit outputting a combined power obtained by combining power input to the first input terminal and power input to the second input terminal to the load circuit;
a first power-supply input terminal into which power supplied to the first input terminal is input from a first power supply;
a second power-supply input terminal into which power supplied to the second input terminal is input from a second power supply different from the first power supply;
a power-receiving circuit configured to receive power input from the first power supply to the first power-supply input terminal; and
a mode control circuit configured to cause an operation mode of the combining circuit to transition between a first operation mode and a second operation mode depending on a magnitude of a maximum power consumption of the load circuit, wherein
power output from the power-receiving circuit is input to the first input terminal of the combining circuit,
standards for the first power supply includes a first standard and a second standard capable of supplying a larger power than the first standard,
the power-receiving circuit conforms to the first standard,
the first operation mode is an operation mode in which power input to the first input terminal is output to the load circuit,
the second operation mode is an operation mode in which the combined power is output to the load circuit.
